(19) United States
(12) Patent Application Publication
(10) Pub. No.: US 2014/0049139 A1
(43) Pub. Date: Feb. 20, 2014

(54) METHOD FOR WINDING CONTROL OF POLE CHANGEABLE STATOR AND ELECTRO-MECHANICAL CONVERSION APPARATUS USING THE SAME

(71) Applicants: Ming-Tsan Peng, Taoyuan County (TW); Tzong-Shi Liu, Hsinchu City (TW); Kai-Ting Huang, Taichung City (TW)

(72) Inventors: Ming-Tsan Peng, Taoyuan County (TW); Tzong-Shi Liu, Hsinchu City (TW); Kai-Ting Huang, Taichung City (TW)

(73) Assignee: Industrial Technology Research Institute, Hsin-Chu (TW)

(21) Appl. No.: 13/668,352

(22) Filed: Nov. 5, 2012

(30) Foreign Application Priority Data
Aug. 14, 2012 (TW) 101129353

(51) Int. Cl. H02K 15/095; H02K 11/00

(52) U.S. Cl. 310/68 R; 29/596

(57) ABSTRACT

A winding method for pole changeable stator is provided by determining a plurality of classification conditions according to plural types of pole, a plural phases, and current characteristic of the winding coupled to each slot of the stator before and after the pole change, coupling the winding of each slot meeting each classification condition thereby obtaining a plurality of winding groups respectively corresponding to the plurality of classification conditions, and, finally, coupling the plurality of winding groups by a plurality of switching elements so as to form a pole changeable stator. The pole changeable stator can be utilized to be an electro-mechanical conversion apparatus such as power generator or motor

### CROSS REFERENCE TO RELATED APPLICATION

The present application is based on, and claims priority from, Taiwan (International) Application Serial Number 101129353, filed on Aug. 14, 2012, the disclosure of which is hereby incorporated by reference herein in its entirety.

### TECHNICAL FIELD

The present disclosure relates to a stator winding technology, and more particularly, to a winding method for pole changeable stators and the electro-mechanical conversion apparatus using the same.

### TECHNICAL BACKGROUND

Electric vehicle (EV), being an automobile that is propelled by one electric motor or more, has benefits compared to conventional internal combustion engine automobiles, including a significant reduction of carbon dioxide emission and less dependence on fossil fuel. Therefore, it is even being considered to be the car of the future.

Nevertheless, in all kinds of EV applications, it is importance to have an electric motor capable of adapting its rotation speed in response to different driving conditions so as to provide the corresponding EV with sufficient driving power accordingly at all time. Thus, it is noted that the market competitiveness of EVs can be increased by having an electric motor with a wide range of speed adjustment for providing sufficient power to EVs under all kinds of driving conditions. However, since the motor speed change is generally achieved through the control of a controller, the corresponding change in the power output of the motor is restricted in a comparatively small range. On the other hand, it is noted that the output power curve of a motor can vary greatly when the pole of its stator is changed, no matter that motor is a permanent magnet motor, an induction motor or an electric generator. Therefore, it is generally recognized that motor speed adjustment can be carried out effective by the changing of pole in its stator.

However, the amount of power switching elements that are used for enabling pole changing must be carefully controlled so as to minimize the relating cost. In addition to that, another key factor for achieving a good pole changing method is that: the enabling of pole changing should not have any adverse affect upon the slot fill rate of the stator without causing any reduction to the output power of the motor. There are already many pole change techniques that are currently available, such as those disclosed in U.S. Pat. No. 7,598,648 and U.S. Pat. No. 5,825,111. In those conventional methods, the pole change in a stator is enabled via the operation of a plurality of power electronic elements with corresponding series and parallel circuit design, and thereby, the motor speed can be changed accordingly.

### TECHNICAL SUMMARY

The present disclosure relates to a winding method for a pole changeable stator with single-layer winding or multi-layer winding, that is designed for establishing a plurality of classification conditions according to various characteristics, including poles, current paths, phases and so on, so as to couple the coils received in stator slots conforming to the same classification condition for thereby obtaining a plurality of winding groups respectively corresponding to the plural classification conditions, and then, enabling the plural winding groups to be electrically coupled to one another using a plurality of switching elements so as to allow the pole of the stator to be changed according to the serial connection configuration and parallel connection configuration enabled by the plural switch elements.

In an exemplary embodiment, the present disclosure provides a winding method for a pole changeable stator, which comprises the steps of: establishing a stator winding according to the amount of slot in a stator as well as a specific phase selected from a plurality of phases and a plural types of pole that are intended to be switchably and selectively enabled in the stator while allowing each slot to house a coil; determining a plurality of classification conditions according to the type of pole of the stator, the plural phases, and the current characteristic of the coil of each slot in the stator before and after a pole change; electrically coupling the coils in slots conforming to the same classification condition for thereby obtaining a plurality of winding groups respectively corresponding to the plural classification conditions while allowing each winding group to act corresponding to at least one of the plural types of pole, at least one phase of the plural phases, and the current characteristic of the at least one type of pole; and enabling the plural winding groups to be electrically coupled to one another using a plurality of switching elements so as to form a pole changeable stator.

In another exemplary embodiment, the present disclosure provides an electro-mechanical conversion apparatus, which comprises: a stator, having a plurality of slots and a plurality of winding groups configured thereat in a manner that each slot has a coil housed therein, and each of the winding group is formed by connecting the coils in the slots conforming to one same classification condition selected from a plurality of classification conditions while allowing each winding group to act corresponding to at least one of a plural types of pole, at least one phase of various phase phases, and current characteristic of the at least one type of pole; a plurality of switching elements, electrically connecting to the plural winding groups; a control unit, for controlling the plural switching elements to change the pole of the stator according to the type of pole that is intended for the stator; and a rotor, disposed on the stator while allowing the rotor to rotate inside the stator.

In another exemplary embodiment, the present disclosure provides an electro-mechanical conversion apparatus, adapted for switching between 2N-pole operation and 6N-pole operation, where N is a natural number, which comprises: a stator, formed with 18N slots while enabling each slot to house and couple to a coil; wherein, all the coils of U-phase in the slots of the stator corresponding 2N-pole operation are connected in series so as to form a first winding group; all the coils of V-phase in the slots of the stator corresponding 2N-pole operation are connected in series so as to form a second winding group; all the coils of W-phase in the slots of the stator corresponding 2N-pole operation are connected in series so as to form a third winding group; all the coils of U-phase in the slots of the stator corresponding 6N-pole operation are connected in series so as to form a fourth winding group; all the coils of W-phase in the slots of the stator corresponding 6N-pole operation are connected in series so as to form a fifth winding group; and thereby, during the 2N-pole operation, the first winding group, the second winding group and the third winding group are arranged coupling to one another in a first coupling manner; and during the 6N-pole operation, the first winding group, the second winding group and the third winding group are arranged coupling to one another into a 6N-pole V-phase circuit while allowing the fourth winding group and the fifth winding group to be arranged coupling to one another in a second coupling manner.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a flow chart depicting steps of a winding method for a pole changeable stator according to an exemplary embodiment of the present disclosure.

FIG. 2 is a schematic diagram showing a stator winding according to an exemplary embodiment of the present disclosure.

FIG. 3A to FIG. 3F are schematic diagrams showing current paths in stator windings of FIG. 2 in U-phase, V-phase and W-phase connections in respective.

FIG. 4A to FIG. 4C are schematic diagrams showing current paths in stator windings of FIG. 2 having various winding groups to be formed according to different classification conditions defined in the present disclosure.

FIG. 5A and FIG. 5B are circuit diagrams showing a pole changeable stator according to an embodiment of the present disclosure.

FIG. 6 is a flow chart depicting steps of a winding method for a pole changeable stator according to another exemplary embodiment of the present disclosure.

FIG. 7 is a circuit diagram showing a pole changeable stator with compensation winding according to an embodiment of the present disclosure.

FIG. 8A and FIG. 8B are schematic diagrams showing winding groups of the present disclosure that are connected in Y connection.

FIG. 8C and FIG. 8D are schematic diagrams showing winding groups of the present disclosure that are connected in delta connection.

FIG. 9 is a schematic diagram showing a stator winding according to another exemplary embodiment of the present disclosure.

FIG. 10 is a schematic diagram showing the coupling of coils in the stator winding of FIG. 9.

FIG. 11 is a schematic diagram showing a stator winding according to further another exemplary embodiment of the present disclosure.

FIG. 12 is a schematic diagram showing the coupling of coils in the stator winding of FIG. 11.

FIG. 13 is a schematic diagram showing the switching between 4-pole operation and 12-pole operation in the stator winding of FIG. 9.

FIG. 14 is a schematic diagram showing the coupling of coils in the stator winding of FIG. 13.

FIG. 15 is a schematic diagram showing a signal-phase 2-pole/6-pole changeable double-layer stator.

FIG. 16 is a schematic diagram showing a signal-phase 2-pole/6-pole changeable double-layer stator with auxiliary winding.

FIG. 17 is a circuit diagram of a signal-phase 2-pole/6-pole changeable double-layer stator.

FIG. 18 is a circuit diagram of a dual-phase 2-pole/6-pole changeable double-layer stator.

### DESCRIPTION OF THE EXEMPLARY EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

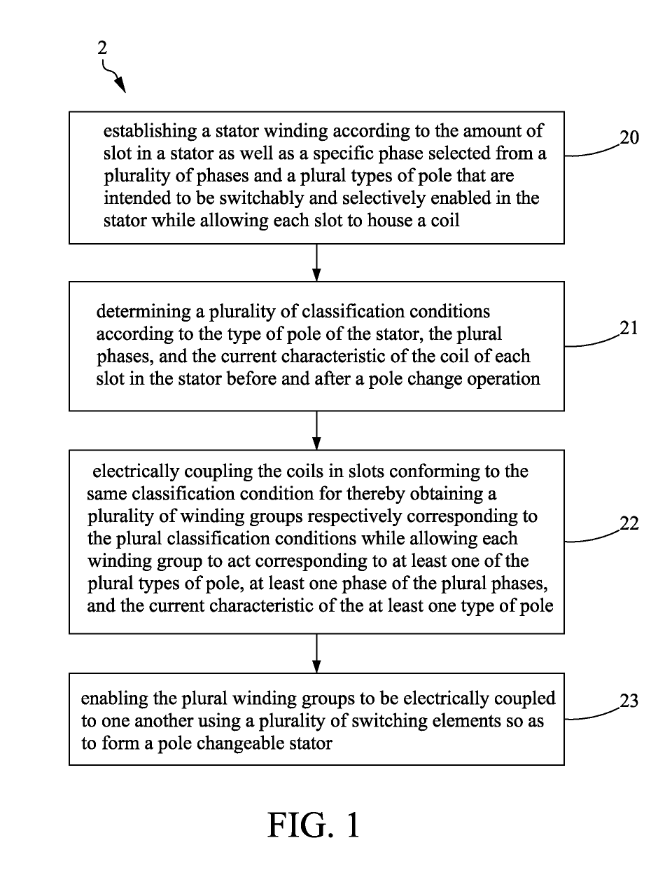

Please refer to FIG. 1, which is a flow chart depicting steps of a winding method for a pole changeable stator according to another exemplary embodiment of the present disclosure. As shown in FIG. 1, the winding method starts from the step 20. At step 20, a stator winding is established according to the amount of slot in a stator as well as a specific phase selected from a plurality of phases and a plural types of pole that are intended to be switchably and selectively enabled in the stator while allowing each slot to house a coil; and then the flow proceeds to step 21.

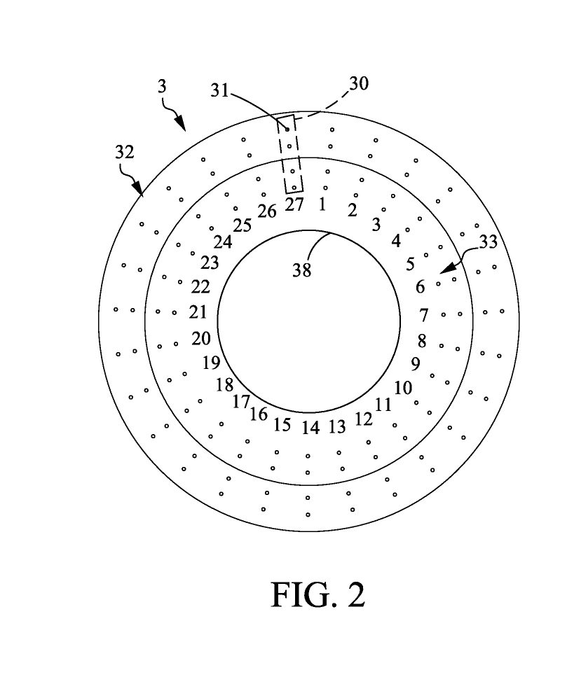

Please refer to FIG. 2, which is a schematic diagram showing a stator winding according to an exemplary embodiment of the present disclosure. In FIG. 2, the slots 30 in the stator are numbered from 1 to 27 clockwisely, whereas each slot 30 is provided for housing a coil 13. In this embodiment, the stator winding 3 is a two-layer winding composed of an outer-layer winding 32 and an inner-layer winding 33. It is noted that the amount of slots 30 that is formed on the stator is not limited by this embodiment, and also the stator winding 3 is not limited to be the two-layer winding, but can be a single-layer winding or a multi-layer winding as required. Moreover, the stator can be a single-phase stator or a multi-phase stator, and in this embodiment, a three-phase stator is used for illustration, i.e. U-phase, V-phase and W-phase. In addition, there are specific types of pole that can be switchably and selectively enabled in the stator. In this embodiment, the stator with 27 slots can be adapted for switching between 6-pole operation and 18-pole operation. It is noted that the stator winding can be adapted either for a motors or for a generator; whereas the motor can be an induction motor, a magnetic reluctance motor or a permanent magnet motor. M this embodiment, the rotor can be a squirrel-cage rotor, but is not limited thereby, and thus can be a phase-wound rotor for instance. After the configuration of the stator has been determined at the step 20 of FIG. 1, the flow proceeds to step 21. At the step 21, a plurality of classification conditions is determined according to the type of pole of the stator, the plural phases, and the current characteristic of the coil of each slot in the stator before and after a pole change operation; and then the flow proceeds to step 22. It is noted that the current characteristic can be an attribute selected from the group consisting of: current direction, current magnitude and the combination thereof. In this embodiment, the current characteristic is defined to be current direction, but is not limited thereby, In another embodiment, the magnitude of current flowing in the stator winding can be used as the current characteristic. Moreover, each of the plural classification conditions is a combination of at least two terms selected from the groups consisting of the following term a to term x, which are:
a. U-phase is excited at N pole and U-phase is excited at M pole, and current direction remains unchanged before and after the pole change operation;
b. U-phase is excited at N pole and U-phase is excited at M pole, and current direction is revered before and after the pole change operation;
c. U-phase is excited at N pole and V-phase is excited at M pole, and current direction remains unchanged before and after the pole change operation;
d. U-phase is excited at N pole and V-phase is excited at M pole, and current direction is reversed before and after the pole change operation;
e. U-phase is excited at N pole and W-phase is excited at M pole, and current direction remains unchanged before and after the pole change operation;
f. U-phase is excited at N pole and W-phase is excited at M pole, and current direction is reversed before and after the pole change operation;
g. V-phase is excited at N pole and U-phase is excited at M pole, and current direction remains unchanged before and after the pole change operation;
h. V-phase is excited at N pole and U-phase is excited at M pole, and current direction is reversed before and after the pole change operation;
i. V-phase is excited at N pole and V-phase is excited at M pole, and current direction remains unchanged before and after the pole change operation;
j. V-phase is excited at N pole and V-phase is excited at M pole, and current direction is reversed before and after the pole change operation;
k. V-phase is excited at N pole and W-phase is excited at M pole, and current direction remains unchanged before and after the pole change operation;
l. V-phase is excited at N pole and W-phase is excited at M pole, and current direction is reversed before and after the pole change operation;
m. W-phase is excited at N pole and U-phase is excited at M pole, and current direction remains unchanged before and after the pole change operation;
n. W-phase is excited at N pole and U-phase is excited at M pole, and current direction is reversed before and after the pole change operation;
o. W-phase is excited at N pole and V-phase is excited at M pole, and current direction remains unchanged before and after the pole change operation;
p. W-phase is excited at N pole and V-phase is excited at M pole, and current direction is reversed before and after the pole change operation;
q. W-phase is excited at N pole and W-phase is excited at M pole, and current direction remains unchanged before and after the pole change operation;
r. W-phase is excited at N pole and W-phase is excited at M pole, and current direction is reversed before and after the pole change operation;
s. no excitation at N pole and U-phase is excited at M pole;
t. no excitation at N pole and V-phase is excited at M pole;
u. no excitation at N pole and W-phase is excited at M pole;
v. U-phase is excited at N pole and no excitation at M pole;
w. V-phase is excited at N pole and no excitation at M pole; and
x. W-phase is excited at N pole and no excitation at M pole.

The are 24 terms to be selected and used in the classification conditions, in which each of the 24 terms defines a corresponding pole, phase and current characteristic, whereas the current characteristic can be an attribute selected from the group consisting of: current direction, current magnitude and the combination thereof. In addition, in this embodiment, the plural types of pole includes: M pole and N pole, M pole represents 6 pole, N pole represents 18 pole, and the plural phases includes: U-phase, V-phase and W-phase.

After the classification condition is defined, the flow proceeds to step 22. At step 22, the coils in slots conforming to the same classification condition are electrically coupling to one another for thereby obtaining a plurality of winding groups respectively corresponding to the plural classification conditions while allowing each winding group to act corresponding to at least one of the plural types of pole, at least one phase of the plural phases, and the current characteristic of the at least one type of pole; and then the flow proceeds to step 23. In an embodiment of the present disclosure, the step 22 further comprises the steps of: enabling the coils in the slots of the same winding group to be connected in a manner that any two coils of opposite current directions in each winding group are paired and connected to each other until all the coils are paired so as to form a plurality of sub-winding group for each winding group, designated as the step 220; and connecting the plural sub-winding group of the same winding group by a coupling manner so as to achieve the corresponding winding group, designated as the step 221.

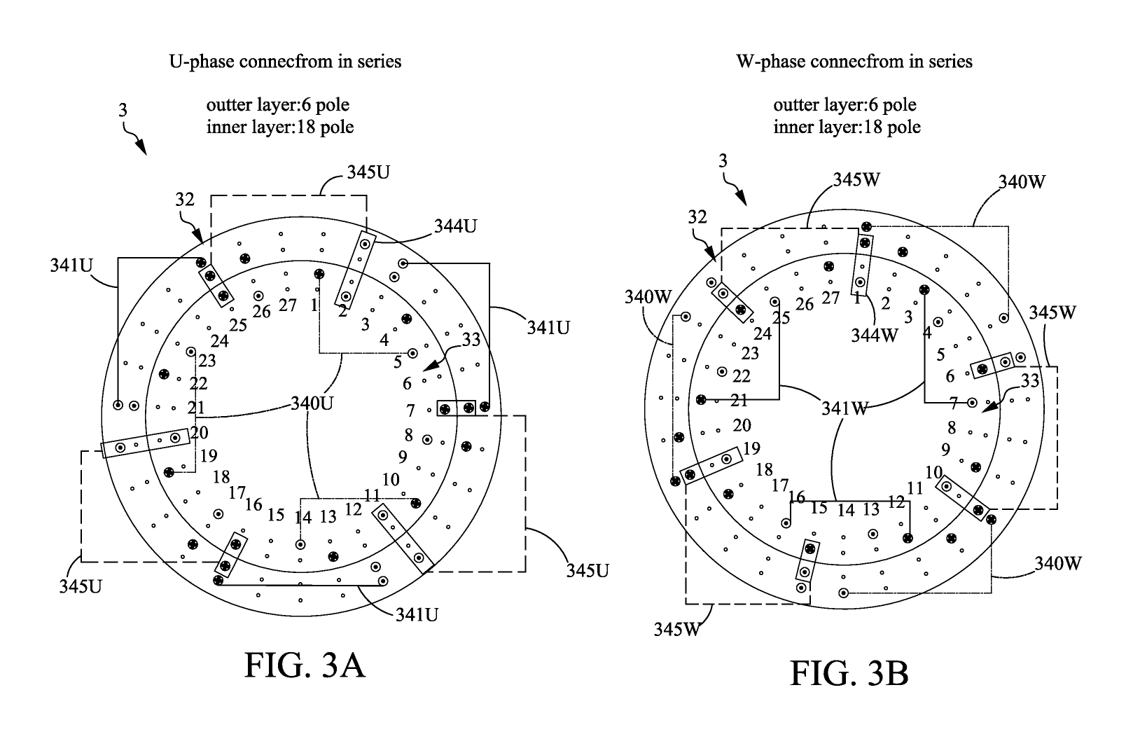

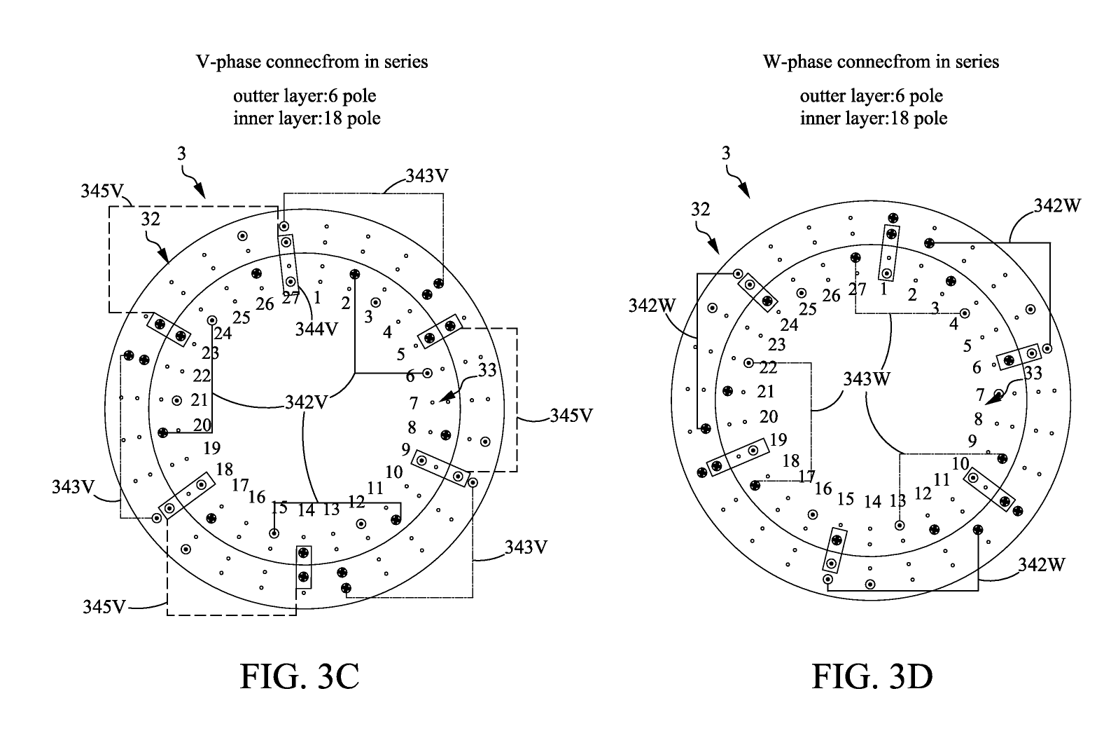

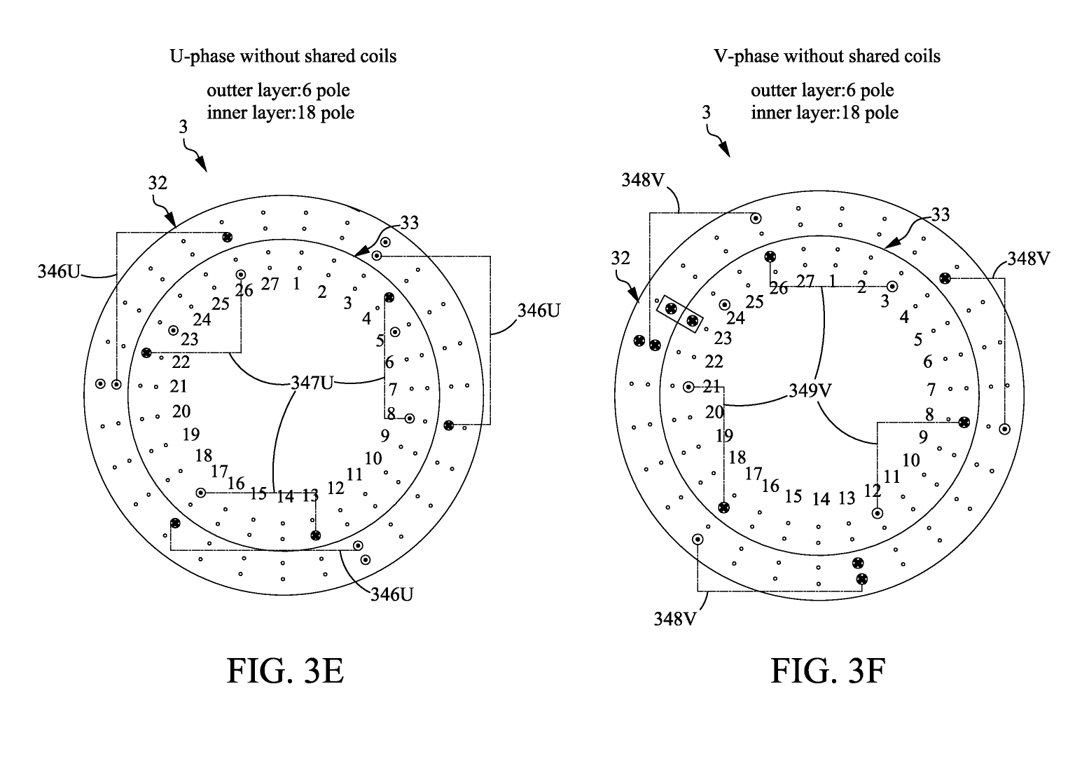

At the step 220, the slots conforming to the same classification condition are identified and selected by an evaluation performing upon the coils in those slots based upon the terms a˜x in a one-by-one manner. Please refer to FIG. 3A to FIG. 3B, which are schematic diagrams showing current paths in stator windings of FIG. 2 in U-phase, and W-phase connections in respective. FIG. 3A is an illustration showing the current directions of a U-phase stator winding at 6-pole and 18-pole in respective; and FIG. 3B is an illustration showing the current directions of a W-phase stator winding at 6-pole and 18-pole in respective. According to the embodiment shown in FIG. 3A and FIG. 3B, slots conforming to the classification condition of term e are identified, and then, by the comparison between the U-phase stator of FIG. 3A and the W-phase stator of FIG. 3B, it is noted that the current direction of slot 1 in the W-phase 6-pole stator winding is the same as that of slot 1 in the U-phase 18-pole stator winding; and the current direction of slot 5 in the W-phase 6-pole stator winding is the same as that of slot 5 in the U-phase 18-pole stator winding. Similarly, the current direction of slot 10 in the W-phase 6-pole stator winding is the same as that of slot 10 in the U-phase 18-pole stator winding; and the current direction of slot 14 in the W-phase 6-pole stator winding is the same as that of slot 14 in the U-phase 18-pole stator winding. The current direction of slot 19 in the W-phase 6-pole stator winding is the same as that of slot 19 in the U-phase 18-pole stator winding; and the current direction of slot 23 in the W-phase 6-pole stator winding is the same as that of slot 23 in the U-phase 18-pole stator winding. After the slots conforming to the same classification condition are identified, the step of enabling the coils in the slots of the same winding group to be connected in a manner that any two coils of opposite current directions in each winding group are paired and connected to each other until all the coils are paired so as to form a plurality of sub-winding group for each winding group is proceeded. Taking the U-phase stator winding for example, the currents in the coil of slot 1 and that of slot 5 are flowing in opposite directions, whereas the current direction of slot 1 is an in-flow direction and the current direction of slot 5 is an out-flow direction; and thereby, the coils of slot 1 and slot 5 are connected in series and named as a sub-winding 1-5. It is noted that the sub-winding 1-5 is shared by the 6-pole configuration and the 18-pole configuration, but the sub-winding 1-5 will be a W-phase stator winding in 18-pole configuration, and on the other hand, the sub-winding 1-5 will be a U-phase stator winding in 6-pole configuration. Similarly, coils of slot 10 and slot 14 are connected in series and named as a sub-winding 10-14; and coils of slot 19 and slot 23 are connected in series and named as a sub-winding 19-23. It is noted that the resulting sub-windings are represented in FIG. 3A and FIG. 3B using the dotted lines 340U and 340W in respective. When a pole change operation is enabled between 6 pole and 18 pole, the aforesaid three sub-windings, i.e. the sub-winding 1-5, the sub-winding 10-14, and the sub-winding 19-23, remain being excited without their current directions to be changed, but with there phases to be changed.

As shown in FIG. 3A and FIG. 3B, the slots conforming to the classification condition of term n also can be identified. It is noted that the current direction of slot 3 in the U-phase 6-pole stator winding is opposite to that of slot 3 in the W-phase 18-pole stator winding; and the current direction of slot 7 in the U-phase 6-pole stator winding is opposite to that of slot 7 in the W-phase 18-pole stator winding. Therefore, the coils of slot 3 and slot 7 are connected in series and named as a sub-winding 3-7. This sub-winding 3-7 can be shared and in a pole-change operation, its phases are changed and current directions are reversed accordingly. Similarly, the current direction of slot 12 in the U-phase 6-pole stator winding is opposite to that of slot 12 in the W-phase 18-pole stator winding; and the current direction of slot 16 in the U-phase 6-pole stator winding is opposite to that of slot 16 in the W-phase 18-pole stator winding. Therefore, the coils of slot 12 and slot 16 are connected in series and named as a sub-winding 12-16. This sub-winding 12-16 can be shared and in a pole-change operation, its phases are changed and current directions are reversed accordingly. The same situation happens to the coils in slot 21 and slot 25, so that the coils in slot 21 and slot 25 are connected and named as sub-winding 12-16. It is noted that in a pole change operation, all the phases of the aforesaid three sub-windings, i.e. the sub-winding 3-7, the sub-winding 12-16 and the sub-winding 21-25 are changed and also their current directions are reversed. The resulting sub-windings are represented in FIG. 3A and FIG. 3B using the dotted lines 341U and 341W in respective.

Please refer to FIG. 3C to FIG. 3D, which are schematic diagrams showing current paths in stator windings of FIG. 2 in V-phase, and W-phase connections in respective. FIG. 3C is an illustration showing the current directions of a V-phase stator winding at 6-pole and 18-pole in respective; and FIG. 3D is an illustration showing the current directions of a W-phase stator winding at 6-pole and 18-pole in respective. According to the embodiment shown in FIG. 3C and FIG. 3D, slots conforming to the classification condition of term k are identified, and then, by the comparison between the U-phase stator of FIG. 3C and the W-phase stator of FIG. 3D, it is noted that the current direction of slot 2 in the V-phase 18-pole stator winding is the same as that of slot 2 in the W-phase 6-pole stator winding; and current direction of slot 6 in the V-phase 18-pole stator winding is the same as that of slot 6 in the W-phase 6-pole stator winding. Thus, the coils of slot 2 and slot 6 are connected in series and named as a sub-winding 2-6. It is noted that the sub-winding 2-2 can be shared but the sub-winding 2-6 will be a W-phase stator winding in 6-pole configuration, and on the other hand, the sub-winding 2-6 will be a V-phase stator winding in 6-pole configuration. Similarly, coils of slot 11 in the V-phase 18-pole stator winding is the same as that of slot 11 in the W-phase 6-pole stator winding; and current direction of slot 15 in the V-phase 18-pole stator winding is the same as that of slot 15 in the W-phase 6-pole stator winding. Thus, the coils in slot 11 and slot 15 are connected in series and named as a sub-winding 11-15; and similarly, coils of slot 20 and slot 24 are connected in series and named as a sub-winding 20-24. It is noted that the resulting sub-windings are represented in FIG. 3C and FIG. 3D using the dotted lines 342V and 342W in respective. When a pole change operation is enabled, the aforesaid three sub-windings, i.e. the sub-winding 2-6, the sub-winding 11-15, and the sub-winding 20-24, remain being excited without their current directions to be changed, but with there phases to be changed.

As shown in FIG. 3C and FIG. 3D, the slots conforming to the classification condition of term p also can be identified. It is noted that the current direction of slot 27 in the V-phase 6-pole stator winding is opposite to that of slot 27 in the W-phase 18-pole stator winding; and the current direction of slot 4 in the V-phase 6-pole stator winding is opposite to that of slot 4 in the W-phase 18-pole stator winding. Therefore, the coils of slot 4 and slot 27 are connected in series and named as a sub-winding 4-27. This sub-winding 4-27 can be shared and in a pole-change operation, its phases are changed and current directions are reversed accordingly. Similarly, the current direction of slot 9 in the V-phase 6-pole stator winding is opposite to that of slot 9 in the W-phase 18-pole stator winding; and the current direction of slot 13 in the V-phase 6-pole stator winding is opposite to that of slot 13 in the W-phase 18-pole stator winding. Therefore, the coils of slot 9 and slot 13 are connected in series and named as a sub-winding 9-13. This sub-winding 9-13 can be shared and in a pole-change operation, its phases are changed and current directions are reversed accordingly. The same situation happens to the coils in slot 18 and slot 22, so that the coils in slot 18 and slot 22 are connected and named as sub-winding 18-22. It is noted that in a pole change operation, all the phases of the aforesaid three sub-windings, i.e. the sub-winding 4-27, the sub-winding 9-13 and the sub-winding 18-22 are changed and also their current directions are reversed. The resulting sub-windings are represented in FIG. 3C and FIG. 3D using the dotted lines 343V and 341W in respective.

Back to FIG. 3A, at the condition of U-phase 6-pole/18-pole switching, the slots conforming to the terms a can be identified, which are the slot 2, slot 11, slot 16, slot 20 and slot 25, that are framed by blocks 344U It is noted that the current direction in those slots conforming to the terms a remained unchanged before and after the pole change as well as their phases remain to be U-phase also. Similarly, the coils in those slots with opposite current directions are connected in series, that is, the coils of slot 2 is connected to the coil in slot 25 in series and named as a sub-winding 2-25; and the coils of slot 7 is connected to the coil in slot 11 in series and named as a sub-winding 7-11; and the coils of slot 16 is connected to the coil in slot 20 in series and named as a sub-winding 16-20. It is noted that in a pole change operation, all the phases of the aforesaid three sub-windings, i.e. the sub-winding 2-25, the sub-winding 7-11 and the sub-winding 16-20 are not changed and also their current directions remains the same at U-phase. The resulting sub-windings are represented in FIG. 3A using the dotted lines 345U.

Back to FIG. 3B, at the condition of U-phase 6-pole/18-pole switching, the slots conforming to the terms r can be identified, which are the slot 1, slot 6, slot 10, slot 15, slot 19, and slot 24, that are framed by blocks 344W. It is noted that the current direction in those slots conforming to the terms r are opposite before and after the pole change while their phases remain to be W-phase. The coils of slot 1 is connected to the coil in slot 24 in series and named as a sub-winding 1-24; and the coils of slot 6 is connected to the coil in slot 10 in series and named as a sub-winding 6-10; and the coils of slot 15 is connected to the coil in slot 19 in series and named as a sub-winding 15-19. It is noted that in a pole change operation, all the phases of the aforesaid three sub-windings before and after pole change, i.e. the sub-winding 1-24, the sub-winding 6-10 and the sub-winding 15-19, are reversed while allowing their phases to remain unchanged at W-phase. The resulting sub-windings are represented in FIG. 3B using the dotted lines 345W.

In FIG. 3C, the slots conforming to the terms i can be identified, which are the slot 5, slot 9, slot 14, slot 18, slot 23, and slot 27, that are framed by blocks 344V. It is noted that the current direction in those slots conforming to the terms i remain unchanged before and after the pole change as well as their phases remain to be V-phase. The coils of slot 27 is connected to the coil in slot 23 in series and named as a sub-winding 23-27; and the coils of slot 5 is connected to the coil in slot 9 in series and named as a sub-winding 5-9; and the coils of slot 14 is connected to the coil in slot 18 in series and named as a sub-winding 14-18. It is noted that in a pole change operation, all the phases of the aforesaid three sub-windings before and after pole change, i.e. the sub-winding 23-27, the sub-winding 5-9 and the sub-winding 14-18, remain unchanged and also their phases to remain unchanged at V-phase. The resulting sub-windings are represented in FIG. 3C using the dotted lines 345V.

Please refer to FIG. 3E to FIG. 3F, which are schematic diagrams showing current paths in slots of stator windings of FIG. 2 that are not shared in U-phase, and V-phase connections at different pole configurations in respective. FIG. 3E is an illustration showing the current directions of a U-phase stator winding at 6-pole and 18-pole in respective; and FIG. 3F is an illustration showing the current directions of a V-phase stator winding at 6-pole and 18-pole in respective. Moreover, the slots that are to be described and illustrated in FIG. 3E and FIG. 3F are those having their coils not connected corresponding to and classified by the classification conditions of FIG. 3A to FIG. 3D. In FIG. 3E, the slots conforming to the terms s of U-phase 6-pole stator winding can be identified, which are the slot 3, slot 8, slot 12, slot 17, slot 21, and slot 26. The coils of slot 3 is connected to the coil in slot 8 in series and named as a sub-winding 3-8; and the coils of slot 12 is connected to the coil in slot 17 in series and named as a sub-winding 12-17; and the coils of slot 21 is connected to the coil in slot 26 in series and named as a sub-winding 21-26. The three sub-windings are excited at 6-pole configuration and are represented by the dotted line 346U. Moreover, in FIG. 3E, the slots conforming to the terms v of U-phase 18-pole stator winding can also be identified, which are the slot 4, slot 8, slot 13, slot 17, slot 22, and slot 26. The coils of slot 4 is connected to the coil in slot 8 in series and named as a sub-winding 4-8; and the coils of slot 13 is connected to the coil in slot 17 in series and named as a sub-winding 13-17; and the coils of slot 22 is connected to the coil in slot 26 in series and named as a sub-winding 22-26. The three sub-windings are excited at 18-pole configuration and are represented by the dotted line 347U.

In FIG. 3F, the slots conforming to the terms t of V-phase 6-pole stator winding can be identified, which are the slot 4, slot 8, slot 13, slot 17, slot 22, and slot 26. The coils of slot 4 is connected to the coil in slot 8 in series and named as a sub-winding 4-8; and the coils of slot 13 is connected to the coil in slot 17 in series and named as a sub-winding 13-17; and the coils of slot 22 is connected to the coil in slot 26 in series and named as a sub-winding 22-26. The three sub-windings are excited at 6-pole configuration and are represented by the dotted line 348V. Moreover, in FIG. 3E, the slots conforming to the terms w of V-phase 18-pole stator winding can also be identified, which are the slot 3, slot 8, slot 12, slot 17, slot 21, and slot 26. The coils of slot 3 is connected to the coil in slot 26 in series and named as a sub-winding 3-26; and the coils of slot 8 is connected to the coil in slot 12 in series and named as a sub-winding 8-12; and the coils of slot 17 is connected to the coil in slot 21 in series and named as a sub-winding 17-21. The three sub-windings are excited at 18-pole configuration and are represented by the dotted line 349V.

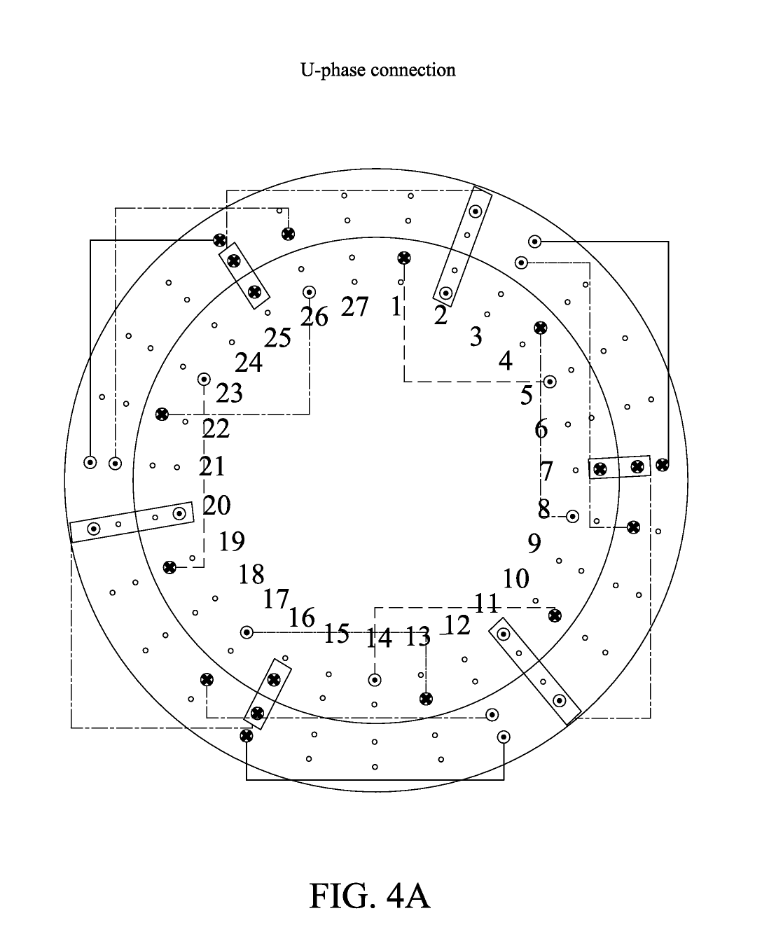

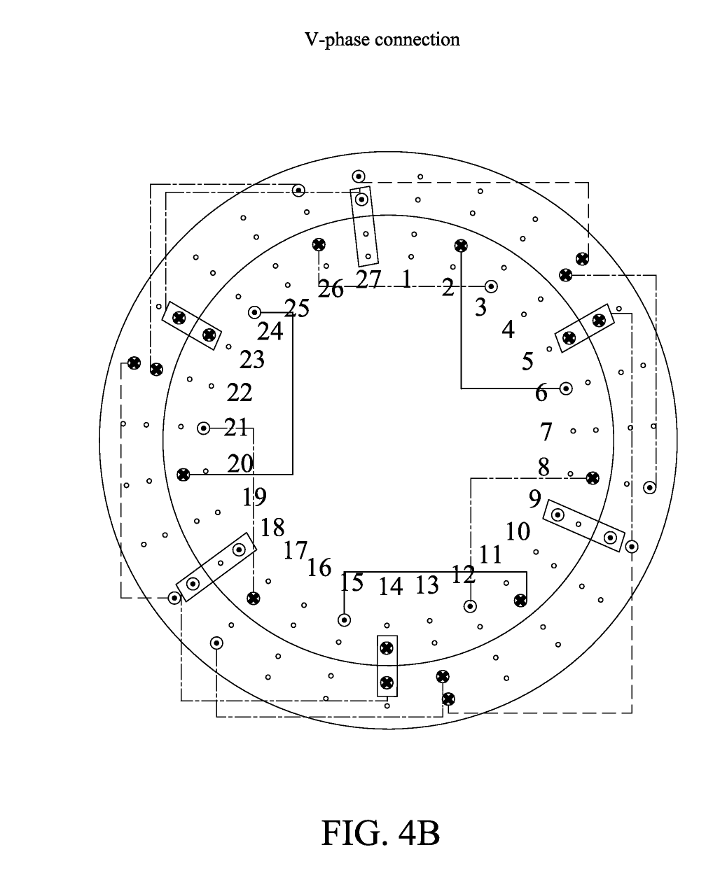

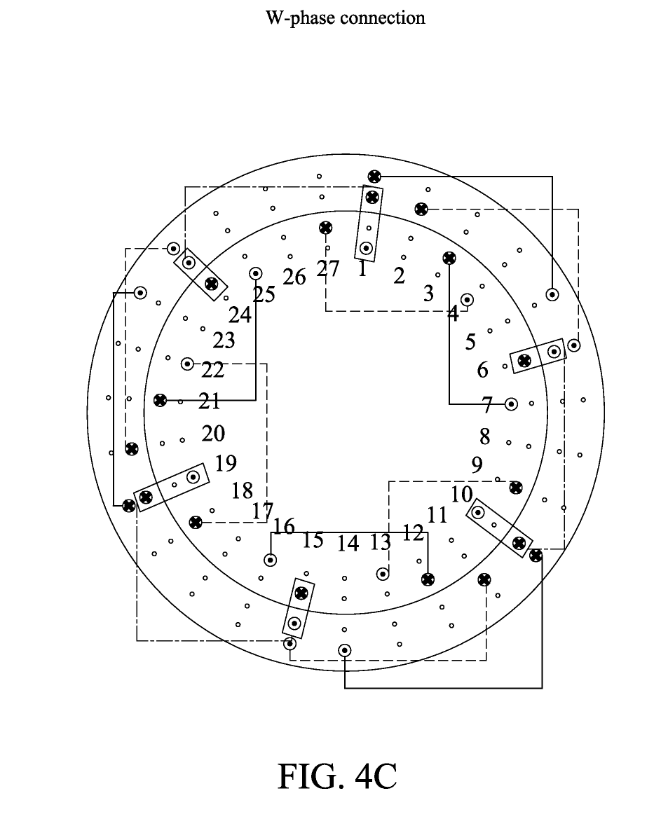

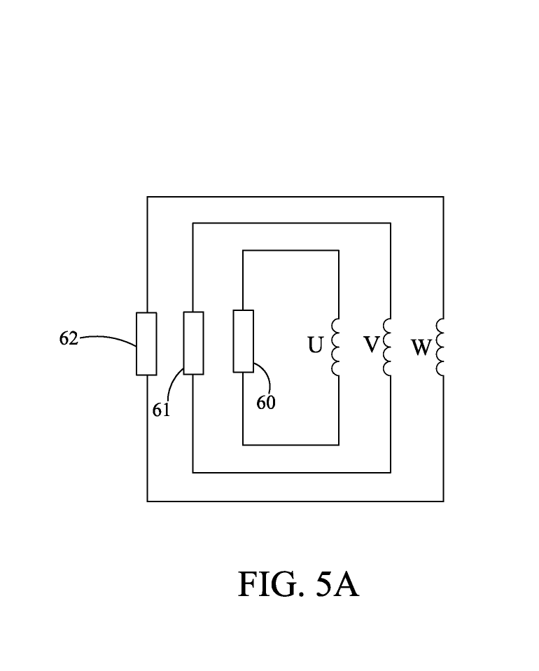

After the step 220 is completed, the flow proceeds to step 221. At step 221, the plural sub-winding group of the same winding group are connected to one another by a coupling manner so as to achieve the corresponding winding group. In this embodiment, the coupling manner can be a connection selected from the group consisting of: a serial connection and a parallel connection. Please refer to FIG. 4A to FIG. 4C, which are schematic diagrams showing current paths in stator windings of FIG. 2 having various winding groups to be formed according to different classification conditions defined in the present disclosure. FIG. 4A shows a U-phase stator winding; FIG. 4B shows a V-phase stator winding; and FIG. 4C shows a W-phase stator winding. Accordingly, by parallel connecting the sub-winding 2-25, the sub-winding 7-11 and the sub-winding 16-20, one corresponding winding group of step 221 that can be represented as U+/u+ winding group, is achieved, in which the capital letter U represent U-phase at 6-pole while the small letter a represents U-phase at 18-pole, and the “+” signs disposed before and after the “/” sign are used for representing that the current direction remain unchanged before and after the pole change. That is, the phases of the winding group consisting of the sub-winding 2-25, the sub-winding 7-11 and the sub-winding 16-20 remain unchanged at U-phase while also maintaining the current direction remain unchanged before and after the pole change.

Similarly, by parallel connecting the sub-winding 3-7, the sub-winding 12-16 and the sub-winding 21-25, one corresponding winding group that can be represented as U+/w− winding group, is achieved, in which the capital letter U represent U-phase at 6-pole while the small letter w represents W-phase at 18-pole, and the “+” sign disposed before the “/” sign and the “−” sign disposed after the “/” sign are used for representing that the current direction is reversed before and after the pole change. In addition, by parallel connecting the sub-winding 3-8, the sub-winding 12-17 and the sub-winding 21-26, another corresponding winding group that can be represented as U/0 winding group, is achieved, in which the capital letter U represent U-phase at 6-pole and the number “0” represents that the 18-pole is not excited. Thereby, a 6-pole U-phase excitation can be achieved by feeding a current of appropriate magnitude to the U+/u+ winding group, the U+/w− winding group and the U/0 winding group for excitation.

Similarly, by parallel connecting the sub-winding 5-9, the sub-winding 14-18 and the sub-winding 23-27, one corresponding winding group that can be represented as V+/v+ winding group, is achieved, in which the capital letter V represent V-phase at 6-pole while the small letter v represents V-phase at 18-pole, and the “+” signs disposed before and after the “/” sign are used for representing that the current direction remain unchanged before and after the pole change. That is, the phases of the winding group consisting of the sub-winding winding 5-9, the sub-winding 14-18 and the sub-winding 23-27 remain unchanged at V-phase while also maintaining the current direction remain unchanged before and after the pole change. In addition, by parallel connecting the sub-winding 4-27, the sub-winding 9-13 and the sub-winding 18-22, another corresponding winding group that can be represented as V+/w-winding group, is achieved, in which the capital letter V represent V-phase at 6-pole while the small letter w represents W-phase at 18-pole, and the “+” sign disposed before the “/” sign and the “−” sign disposed after the “/” sign are used for representing that the current direction is reversed before and after the pole change. Furthermore, by parallel connecting the sub-winding 4-8, the sub-winding 13-17 and the sub-winding 22-26, another corresponding winding group that can be represented as V/0 winding group, is achieved, in which the capital letter V represent V-phase at 6-pole and the number “0” represents that 18-pole is not excited. Thereby, a 6-pole V-phase excitation can be achieved by feeding a current of appropriate magnitude to the V+/v+ winding group, the V+/w− winding group and the V/0 winding group for excitation.

In addition, by parallel connecting the sub-winding 1-24, the sub-winding 6-10 and the sub-winding 15-19, one corresponding winding group that can be represented as W+/w− winding group, is achieved, in which the capital letter W represent W-phase at 6-pole while the small letter w represents W-phase at 18-pole, and the “+” sign disposed before the “/” sign and the “−” sign disposed after the “/” sign are used for representing that the current direction is reversed before and after the pole change. Furthermore, by parallel connecting the sub-winding 1-5, the sub-winding 10-14 and the sub-winding 19-23, another corresponding winding group that can be represented as W+/u+ winding group, is achieved, in which the capital letter W represent W-phase at 6-pole while the small letter a represents U-phase at 18-pole, and t the “+” signs disposed before and after the “/” sign are used for representing that the current direction remain unchanged before and after the pole change. Moreover, by parallel connecting the sub-winding 2-6, the sub-winding 11-15 and the sub-winding 20-24, another corresponding winding group that can be represented as W+/v+ winding group, is achieved, in which the capital letter W represent W-phase at 6-pole while the small letter v represents V-phase at 18-pole, and the “+” signs disposed before and after the “/” sign are used for representing that the current direction remain unchanged before and after the pole change. Thereby, a 6-pole W-phase excitation can be achieved by feeding a current of appropriate magnitude to the W+/w− winding group, the W+/u− winding group and the W+/v+ winding group for excitation.

Furthermore, by parallel connecting the sub-winding 4-8, the sub-winding 13-17 and the sub-winding 22-26, a corresponding winding group that can be represented as 0/u winding group, is achieved, in which the number “0” represents that 6-pole is not excited and the small letter a represents U-phase at 6-pole. By parallel connecting the sub-winding 3-26 the sub-winding 8-12 and the sub-winding 17-21, another corresponding winding group that can be represented as 0/v winding group, is achieved, in which the number “0” represents that 6-pole is not excited and the small letter v represent V-phase at 18-pole.

The winding groups that can be achieved by the operation of the step 221 are listed in Table 1 as following:

TABLE 1

| | | | | Coils in slots that | |
|---|---|---|---|---|---|
| | | 18 | Current | are connected | Representing |
| group | 6 pole | pole | direction | in series | symbol |
| 1 | U- phase | U- phase | same | 25-2, 7-11, 16-20 | 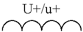 |
| 2 | V- phase | V- phase | same | 5-9, 14-18, 23-27 | 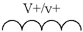 |
| 3 | W- phase | W- phase | opposite | 6-10, 15-19, 24-1 | 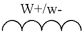 |
| 4 | W- phase | U- phase | same | 25-21, 16-12, 7-3 | 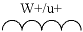 |
| 5 | W- phase | V- phase | same | 4-27, 22-18, 13-9 | 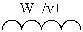 |
| 6 | U- phase | W- phase | opposite | 1-5, 10-14, 19-23 | 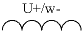 |
| 7 | V- phase | W- phase | opposite | 2-6, 13-15, 20-23 | 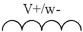 |
| 8 | U- phase | Not excited | — | 26-3, 8-12, 17-21 | 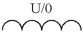 |
| 9 | V- phase | Not excited | — | 4-8, 13-17, 22-26 | 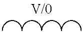 |
| 10 | Not excited | U- phase | — | 4-8, 13-17, 22-26 | 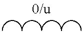 |
| 11 | Not excited | V- phase | — | 26-3, 8-12, 17-21 | 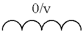 |

As shown in FIG. 1, the step 23 is performed after the completion of step 22. At step 23, the plural winding groups are electrically coupled to one another by the use of a plurality of switching elements so as to form a pole changeable stator. Operationally, during the step 23, the U+/u+ winding group, the 0/u winding group and the W+/u+ winding group are excited by a proper current so as to achieve a 18-pole U-phase stator winding; the V+/v+ winding group, the 0/v winding group and the W+/v+ winding group are excited by a proper current so as to achieve a 18-pole V-phase stator winding; the W+/w− winding group, the U+/w− winding group and the V+/w− winding group are excited by a proper current so as to achieve a 18-pole W-phase stator winding; the U+/u+ winding group, the U+/w− winding group and the U/0 winding group are excited by a proper current so as to achieve a 6-pole U-phase stator winding; the V+/v+ winding group, the V+/w− winding group and the V/0 winding group are excited by a proper current so as to achieve a 6-pole V-phase stator winding; and the W+/u+ winding group, the W+/v+ winding group and the W+/w− winding group are excited by a proper current so as to achieve a 6-pole W-phase stator winding. Therefore, by the use of specific switching elements for coupling the aforesaid stator windings to one another, it is capable of selectively switching between a 6-pole induction motor circuit and a 18-pole induction motor circuit. It is noted that the switching element can be a mechanical switch, a relay, or a power electronic unit.

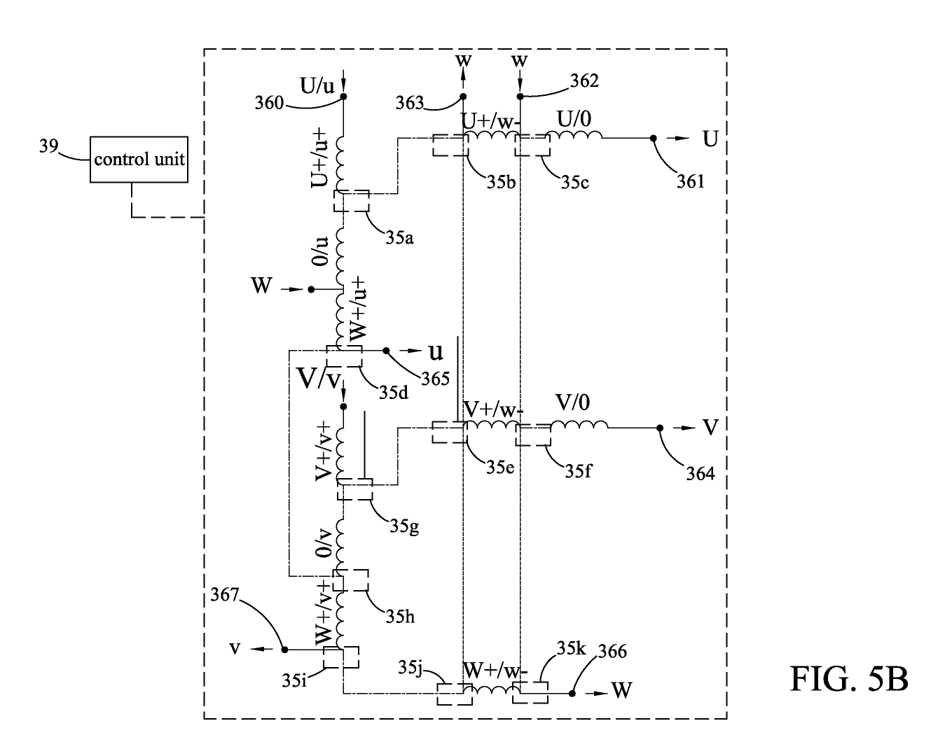

Please refer to FIG. 5A and FIG. 5B, which are circuit diagrams showing a pole changeable stator according to an embodiment of the present disclosure. According to a basic structure of phase independent connection shown in FIG. 5A where the power sources 60, 61 and 62 are connected independently and respectively to a U-phase winding, a V-phase winding, and a W-phase winding, thus any number of the windings selected from those listed in Table 1 that are connected in the phase independent connection manner can be selectively and switchable conducted by the control of a control unit via a plurality of switching elements 35a˜35k, as shown in FIG. 5B. For instance, while it is intended to excite the U-phase 6-pole winding of FIG. 5B, the control unit 39 enables a current entering the circuit via an end 360 to flow through the U+/u+ winding group, and then directs the current toward the U+/w− winding group by the control of the switching elements 35a and 35b, where the current is further being guided toward the U/0 winding group via the switching element 35c so as to flow out of the circuit through another end 361 and thus achieve the intended U-phase 6-pole excitation. Similarly, while it is intended to excite the W-phase 18-pole winding of FIG. 5B, considering that the U+/w− winding group, V+/w− winding group and W+/w− winding group are parallel connected, the control unit 39 enables a current entering the circuit via an end 362 to flow through the V+/w− winding group by the control of the switching element 35c, and then directs the current toward the W+/w− winding group by the control of the switching elements 35f and 35k, and then simultaneously directs the switching element 35j to switch to the V+/w− winding group and the switching element 35e to switch to the U+/w− winding group while allowing the switching element 35b to switch to the end 363 so as to achieve the intended W-phase 18-pole excitation.

It is noted that not all the classification conditions are to be adopted as they are selected according to the amount of slots, phases and poles. Nevertheless, after the design of a stator winding in view of its slots, phases and poles is determined, the current direction of coil in each slot can be determined according to its corresponding phase and pole configurations, so that the aforesaid 24 terms of classification can be used for classifying the windings according to the type of pole of the stator, the plural phases, and current characteristic of the coil of each slot, In addition, for the coils in slots conforming to the same classification condition, they are electrically connected in series under the principle of minimizing the amount of connection wire used and also minimizing the resistance, so that coils are selectively to be serially connected to coils of the same group that are disposed in most adjacent slots.

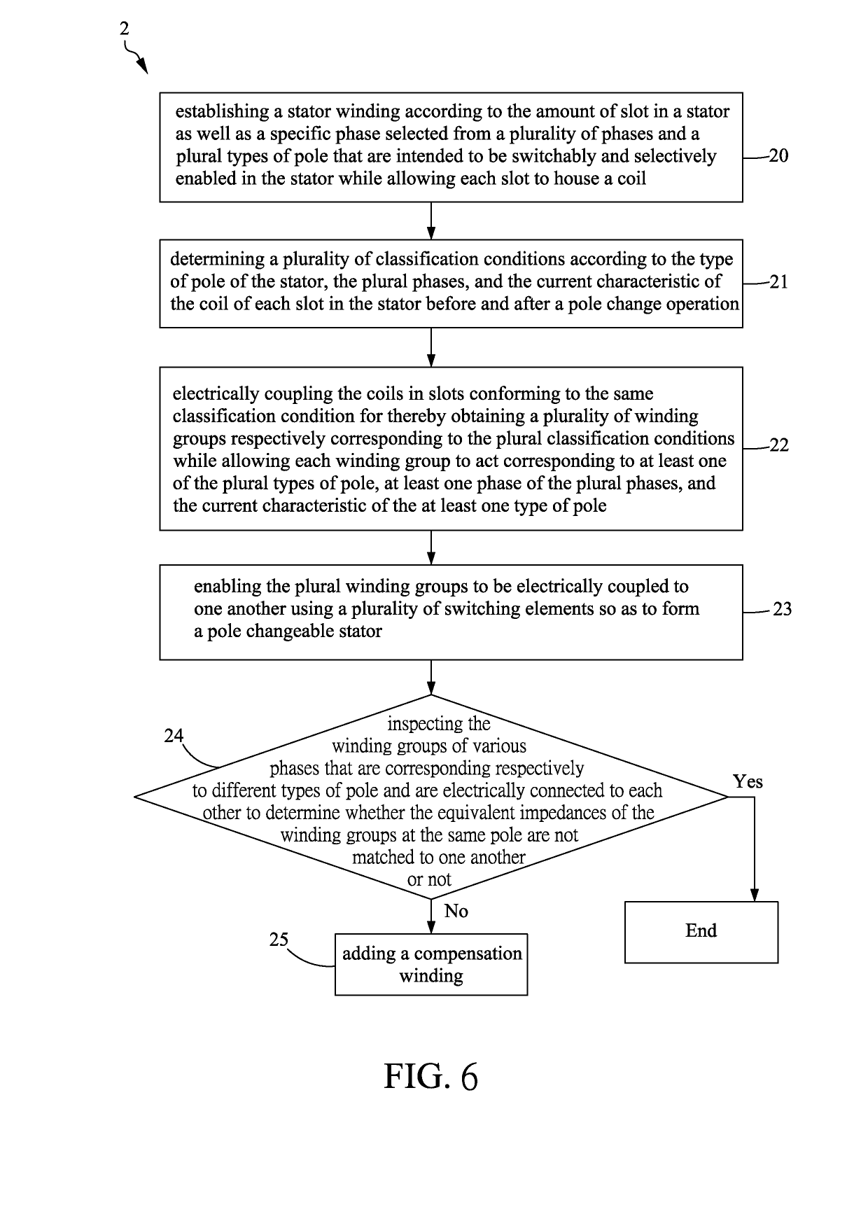

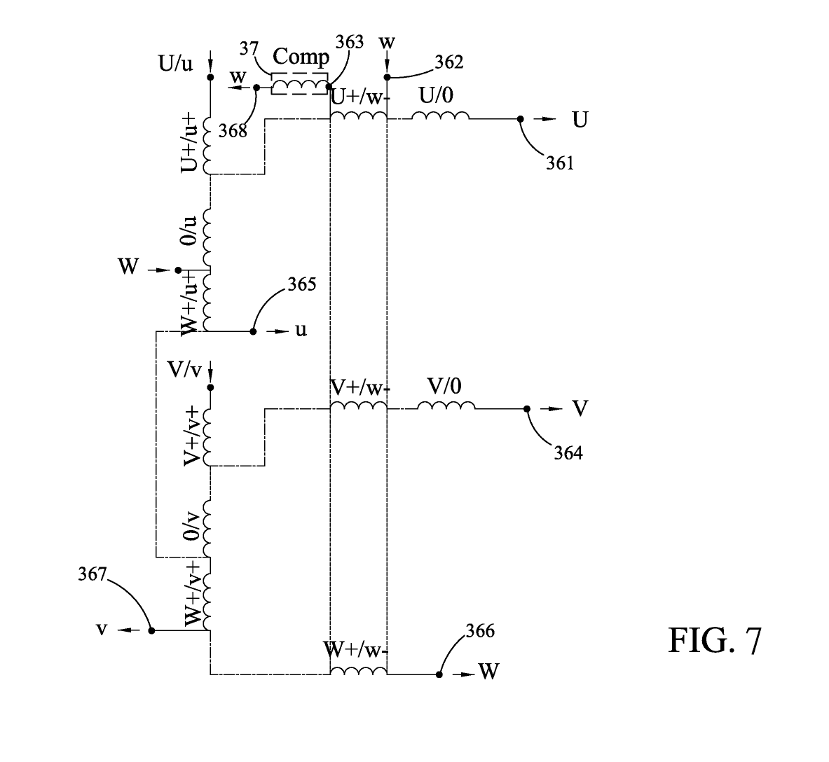

Please refer to FIG. 6, which is a flow chart depicting steps of a winding method for a pole changeable stator according to another exemplary embodiment of the present disclosure. The flow depicted in the embodiment of FIG. 6 is basically the same as that disclosed in FIG. 1, but is different in that: the embodiment of FIG. 6 further comprises the steps of: inspecting the winding groups of various phases that are corresponding respectively to different types of pole and are electrically connected to each other to determine whether the equivalent impedances of the winding groups in a winding set corresponding to one same phase at the same pole for each of the various phases are matched to one another or not, as the step 24 shown in FIG. 6; and determining whether there is one winding group in its winding set whose equivalent impedance is not match to the other winding groups, and then providing a compensation winding to be coupled to the end of the winding set with the unmatched winding group, as the step 25 shown in FIG. 6. Taking the circuit shown in FIG. 5 for instance, it is noted that the 18-pole U-phase winding is achieved by the serial connection of the U+/u+ winding group, 0/u winding group, and W+/u+ winding group, and the 18-pole V-phase winding is achieved by the serial connection of the V+/v+ winding group, 0/v winding group, and W+/v+ winding group, but only the 18-pole W-phase winding is achieved by the parallel connection of the W+/w− winding group, V+/w-winding group, and U+/w− winding group. Thus, the parallel connection of the W-phase winding is the main reason for causing its corresponding equivalent impedance not to match with those of the V-phase and U-phase windings. Therefore, a compensation winding is added, as depicted in step 25. As shown in FIG. 7, the compensation winding 37 is added to the end 363 corresponding to the 18-pole W-phase winding. Thereby, the addition of the compensation winding 37 can make the equivalent impedances of the windings of different phases and poles to conform with one another or can eliminate the high-order harmonics of magnetomotive force (MMF)

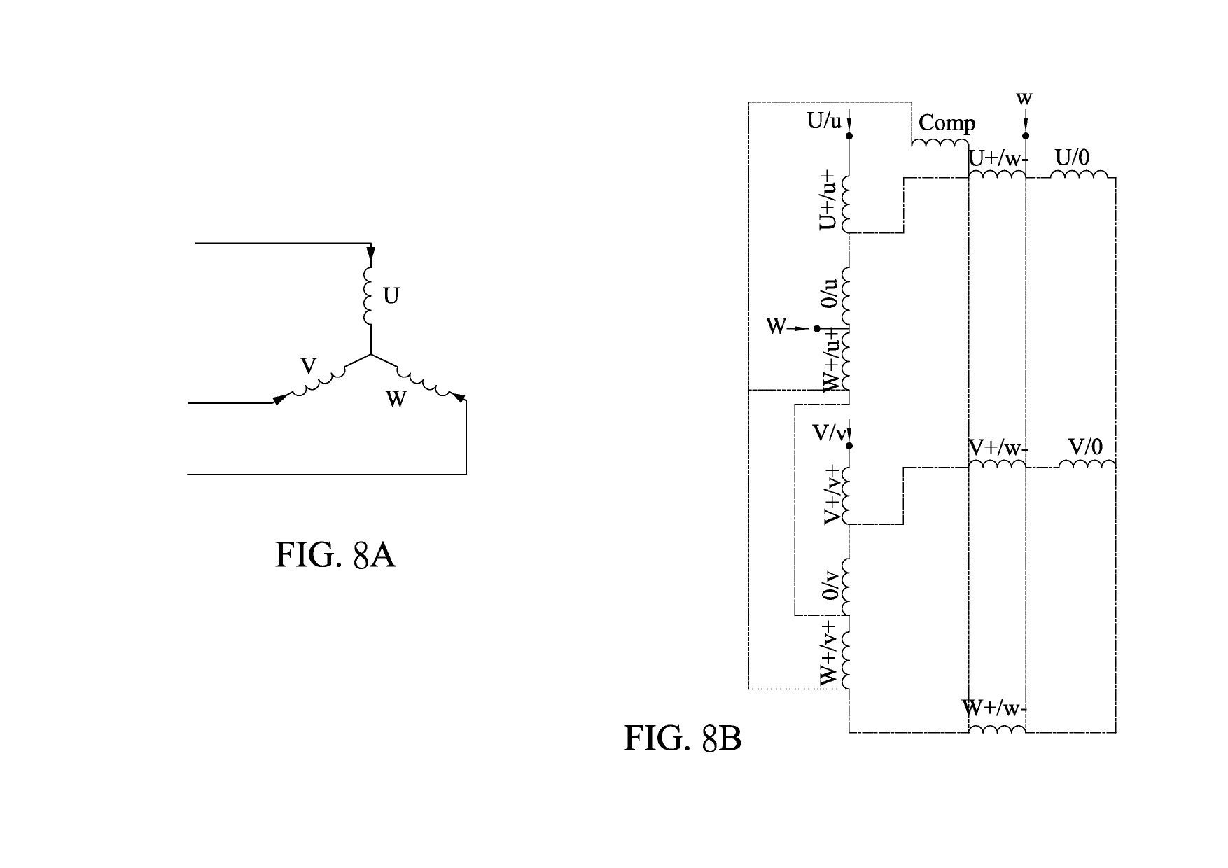

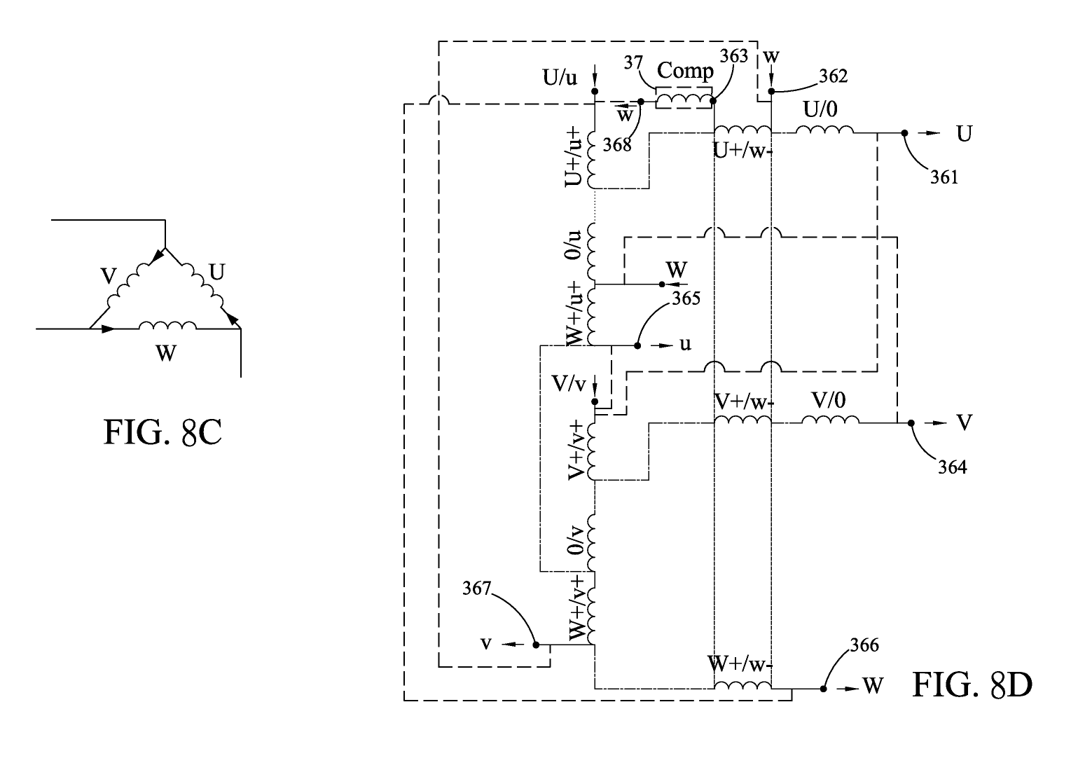

Please refer to FIG. 8A and FIG. 8B are schematic diagrams showing winding groups of the present disclosure that are connected in Y connection. In addition to the phase independent connection shown in FIG. 5 and FIG. 7, the winding groups in the pole changeable stator of the present disclosure can be connected in a Y connection manner. According to a basic structure of Y connection shown in FIG. 8A, a U-phase winding, a V-phase winding, and a W-phase winding are connected in a Y connection. Correspondingly, the Y-connection circuit shown in FIG. 8B is achieved by coupling and joining all the ends 361, 364-368 that are designed for current outflow together. Please refer to FIG. 8C and FIG. 8D are schematic diagrams showing winding groups of the present disclosure that are connected in Y connection. As shown in FIG. 8C and FIG. 8D, the winding groups in the pole changeable stator of the present disclosure can be connected in a delta connection manner, i.e. in a Δ-shape connection. According to a basic structure of delta connection shown in FIG. 8C, a U-phase winding, a V-phase winding, and a W-phase winding are connected in a Δ-shape connection. Correspondingly, the Δ-shape connection circuit is shown in FIG. 8D.

It is noted that the present disclosure is not limited by the 27 slots, double-layer stator winding, and 6-pole/18-pole changeable configuration, and thus it can be applied in induction motors of the stator winding with a single-layer winding or a multi-layer winding, 18N slots, while allowing the poles of the stator to be adapted for switching between 2N-pole operation and 6N-pole operation, whereas N is a natural number, i.e. a 2N/6N pole motor of 18N slots can be achieved in a similar manner using the steps shown in FIG. 1.

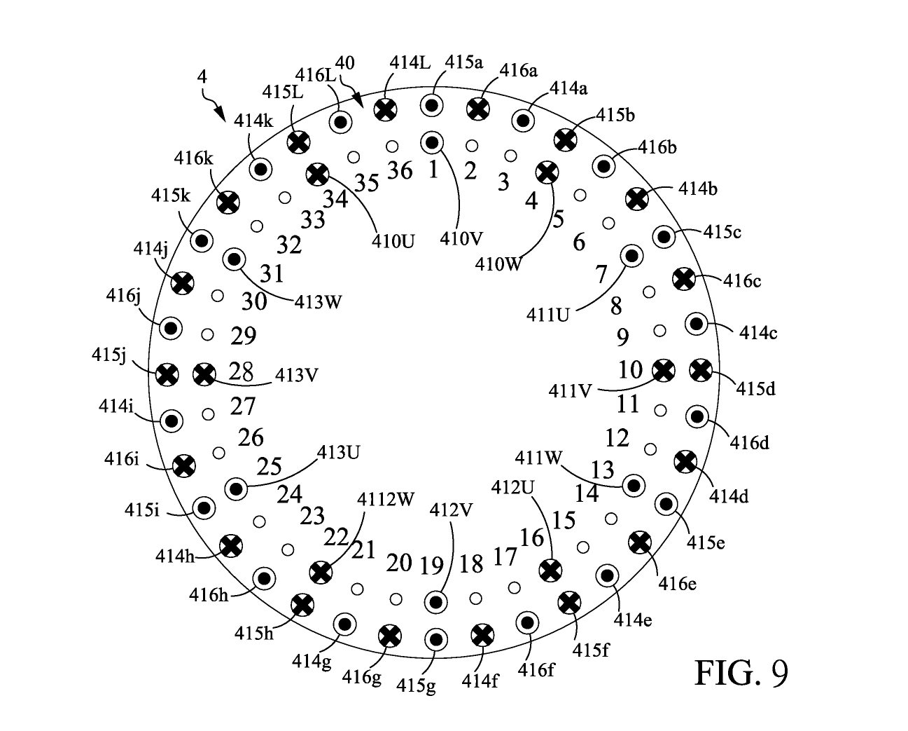

Please refer to FIG. 9, which is a schematic diagram showing a stator winding according to another exemplary embodiment of the present disclosure. In this embodiment shown in FIG. 9, a stator winding 4 is provided similarly according to the step 21 of FIG. 1, which is a single-layer winding 40 with three phases and 36 slots for induction motor. Consequently, as the induction motor of the stator winding 4 is a 2N/6N pole induction motor of 18N slots, the natural number N is equal to 2 and thus the stator winding 4 is substantially a 4-pole/12-pole stator of 36 slots. In addition, the single-layer winding 40 has two rings of windings, i.e. an inner ring for 4-pole operation and an outer ring for 12-pole operation. As shown in FIG. 9, the slots of 4-pole U-phase in the inner ring are numbered by 410U˜413U, the slots of 4-pole V-phase in the inner ring are numbered by 410V˜413V, the slots of 4-pole W-phase in the inner ring are numbered by 410W˜413W, the slots of 12-pole U-phase in the outer ring are numbered by 414a˜413L, the slots of 12-pole V-phase in the outer ring are numbered by 415a˜415L, and the slots of 12-pole W-phase in the outer ring are numbered by 416a˜416L. Moreover, in FIG. 9, the solid dots represent current inflow and the symbol “X” represent current outflow.

Similarly, after step 21, the step 22 is performed for coupling the coils in slots conforming to the same classification condition of terms a˜x for thereby obtaining a plurality of winding groups. It is noted that at 4-pole operation, the 12-pole U-phase winding and the 12-pole W-phase winding are not excited. There can be three conditions happening when the 12-pole V-phase winding is switched into 4-pole. The first condition is that: the 12-pole V-phase winding is switched into 4-pole U-phase winding while enabling current directions to remain unchanged, as they are shown in the coils of slot 17, 16, 25, 34. The second condition is that: the 12-pole V-phase winding is switched into 4-pole V-phase winding while enabling current directions to remain unchanged, as they are shown in the coils of slot 1, 10, 19, 28. The third condition is that: the 12-pole V-phase winding is switched into 4-pole W-phase winding while enabling current directions to remain unchanged, as they are shown in the coils of slot 4, 13, 22, 31. On the other hand, at 12-pole U-phase and 4-pole not excited, a flowing of current can be obtained as indicated by the coils of slots 2, 5, 8, 11, 14, 17, 20, 23, 26, 29, 32, and 35. Moreover, at 12-pole W-phase and 4-pole not excited, a flowing of current can be obtained as indicated by the coils of slots 3, 6, 9, 12, 15, 18, 21, 24, 27, 30, 33, and 36. In step 24, coils of the same classification condition are connected to one another so as to obtain a plurality of winding groups correspondingly, as those listed in Table 2. In Table 2, the capital letters U, V, or W arranged before the sign “/” represent coils for 4-pole operation, and the small letters u or w arranged after the sign “/” represent coils for 12-pole operation, while the signs “+” arranged before and after the sign “/” represent the current directions remain unchanged before and after a pole change operation.

TABLE 2

| | | 12- | Current | Coils in slots that are | Representing |
|---|---|---|---|---|---|
| group | 4-pole | pole | direction | connected in series | symbol |
| 1 | U- phase | V- phase | same | 7-16-25-34 | 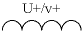 |
| 2 | V- phase | V- phase | same | 1-10-19-28 | 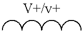 |
| 3 | W- phase | V- phase | same | 4-13-22-31 | 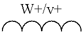 |
| 4 | Not excited | U- phase | — | 2-5-8-11-14-17-20- 23-26-29-32-35 | 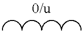 |
| 5 | Not excited | W- phase | — | 3-6-9-12-15-18-21- 24-27-30-33-36 | 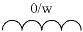 |

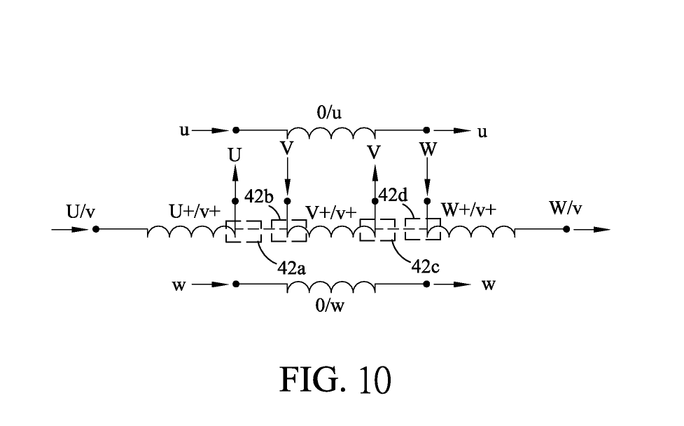

After step 22, the step 23 is performed for the plural winding groups to electrically couple to one another so as to achieve a 4-pole/12-pole changeable pole stator, as the circuit shown in FIG. 10. In FIG. 10, the units 42a˜42d are switching elements.

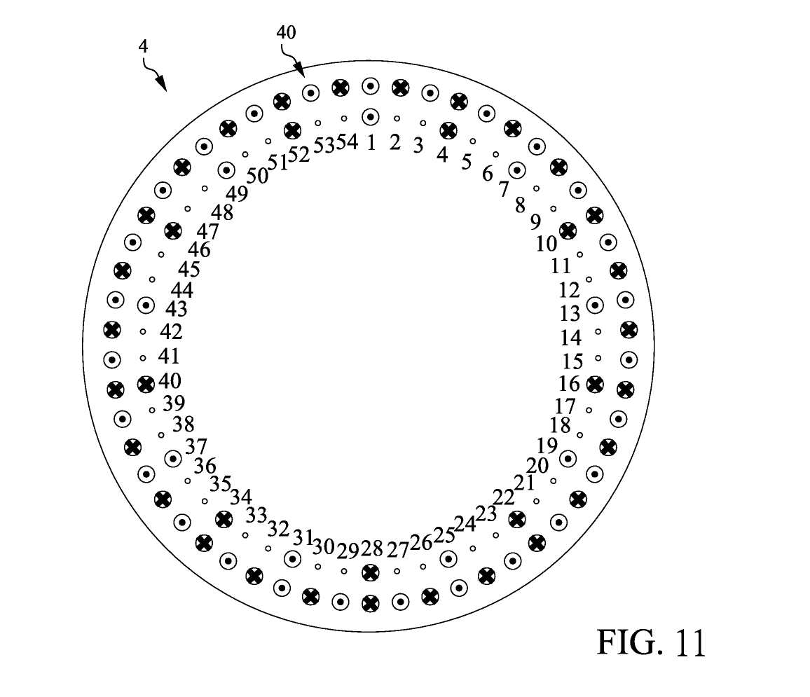

In another embodiment shown in FIG. 11, a stator winding 4 is provided similarly according to the step 21 of FIG. 1, which is adapted for an induction stator of 54 slots. Consequently, as the induction motor of the stator winding 4 is a 2N/6N pole induction motor of 18N slots, the natural number N is equal to 3 and thus the stator winding 4 is substantially a 6-pole/18-pole stator of 54 slots. In addition, the single-layer winding 40 has two rings of windings, i.e. an inner ring for 6-pole operation and an outer ring for 18-pole operation. Moreover, the coils corresponding to 6-pole U-phase winding are coils disposed in slot 7, 16, 25, 34, 43, and 52 of inner ring; the coils corresponding to 6-pole V-phase winding are coils disposed in slot 1, 10, 19, 28, 37, and 46 of inner ring; the coils corresponding to 6-pole W-phase winding are coils disposed in slot 4, 13, 22, 31, 40, and 49 of inner ring; the coils corresponding to 18-pole U-phase winding are coils disposed in slot 3, 6, 9, 12, 15, 18, 21, 24, 27, 30, 33, 36, 39, 42, 45, 48, 51 and 54 of outer ring; the coils corresponding to 18-pole V-phase winding are coils disposed in slot 1, 4, 7, 10, 13, 16, 19, 22, 25, 28, 31, 34, 37, 40, 43, 46, 49, and 52 of outer ring; the coils corresponding to 18-pole W-phase winding are coils disposed in slot 2, 5, 8, 11, 14, 17, 20, 23, 26, 29, 32, 35, 38, 41, 44, 47, 50 and 53 of outer ring. Similarly, in FIG. 11, the solid dots represent current inflow and the symbol “X” represent current outflow.

It is noted that at 6-pole operation, the 18-pole U-phase winding and the 18-pole W-phase winding are not excited. There can be three conditions happening when the 18-pole V-phase winding is switched into 6-pole. The first condition is that: the 18-pole V-phase winding is switched into 6-pole U-phase winding while enabling current directions to remain unchanged, as they are shown in the coils of slot 7, 16, 25, 34, 43 and 52. The second condition is that: the 18-pole V-phase winding is switched into 6-pole V-phase winding while enabling current directions to remain unchanged, as they are shown in the coils of slot 1, 10, 19, 28, 37 and 46. The third condition is that: the 18-pole V-phase winding is switched into 6-pole W-phase winding while enabling current directions to remain unchanged, as they are shown in the coils of slot 4, 13, 22, 31, 40 and 49. The result is listed in the following Table 3.

TABLE 3

| | | 18 | Current | Coils in slots that are | Representing |
|---|---|---|---|---|---|
| group | 6 pole | pole | direction | connected in series | symbol |
| 1 | U- phase | V- phase | same | 7-16-25-34-43-52 | 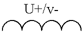 |
| 2 | V- phase | V- phase | same | 1-10-19-28-37-46 | 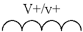 |
| 3 | W- phase | V- phase | same | 4-13-22-31-40-49 | 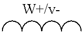 |
| 4 | Not excited | U- phase | — | 2-5-8-11-14-17-20- 23-26-29-32-35- 38-41-44-47-50-53 | 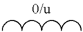 |
| 5 | Not excited | W- phase | — | 3-6-9 12-15-18-21- 24-27-30-33-36-39- 42-45-48-51-54 | 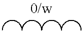 |

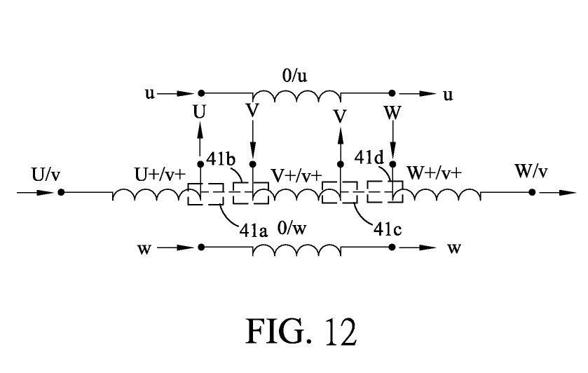

After step 22, the step 23 is performed for the plural winding groups to electrically couple to one another so as to achieve a 6-pole/18-pole changeable pole stator, as the circuit shown in FIG. 12. In FIG. 12, the units 41a˜41d are switching elements. Moreover, in Table 3, the capital letters U, V, or W arranged before the sign “/” represent coils for 6-pole operation, and the small letters a or w arranged after the sign “/” represent coils for 18-pole operation, while the signs “+” arranged before and after the sign “/” represent the current directions remain unchanged before and after a pole change operation.

As shown in FIG. 10 and FIG. 12, in any 2N/6N pole motor of 18N slots, regardless what N is, their corresponding circuitries are the same. For 2N pole operation, U-phase can only be excited at the first winding group, V-phase can only be excited at the second winding group and W-phase can only be excited at the third winding group. Thus, a circuit of 2N pole operation can be achieved by the steps of: serially connecting all the coils in the slots corresponding to 2N pole U-phase winding; serially connecting all the coils in the slots corresponding to 2N pole V-phase winding; serially connecting all the coils in the slots corresponding to 2N pole W-phase winding; and finally connecting the three circuits of the 2N pole 3-phase circuitry in a Y connection manner or a delta connection manner. It is noted that the Y connection manner and the delta connection manner are the same as those depicted in FIG. 8A and FIG. 8C. On the other hand, for 6N pole operation, U-phase can only be excited at the fourth winding group, W-phase can only be excited at the fifth winding group and V-phase can only be excited at the serially connected first, second and third winding group. Therefore, a circuit of 6N pole operation can be achieved by the steps of: serially connecting the first winding group, the second winding group and the third winding group so as to formed a 6N pole V-phase circuit; serially connecting all the coils in the slots corresponding to 6N pole U-phase winding, i.e. the fourth winding group; serially connecting all the coils in the slots corresponding to 6N pole W-phase winding, i.e. the fifth winding group; and finally connecting the three circuits of the 6N pole 3-phase circuitry in a Y connection manner or a delta connection manner. It is noted that a 6N pole V-phase circuit can be formed by serially connecting the 2N pole U-phase circuit, 2N pole V-phase circuit and the 2N pole V-phase circuit. From the foregoing description, it is noted that the stator winding 4 can be adapted for a stator of an electro-mechanical conversion apparatus with 2N/6N switch control. The electro-mechanical conversion apparatus can be a motor or a generator.

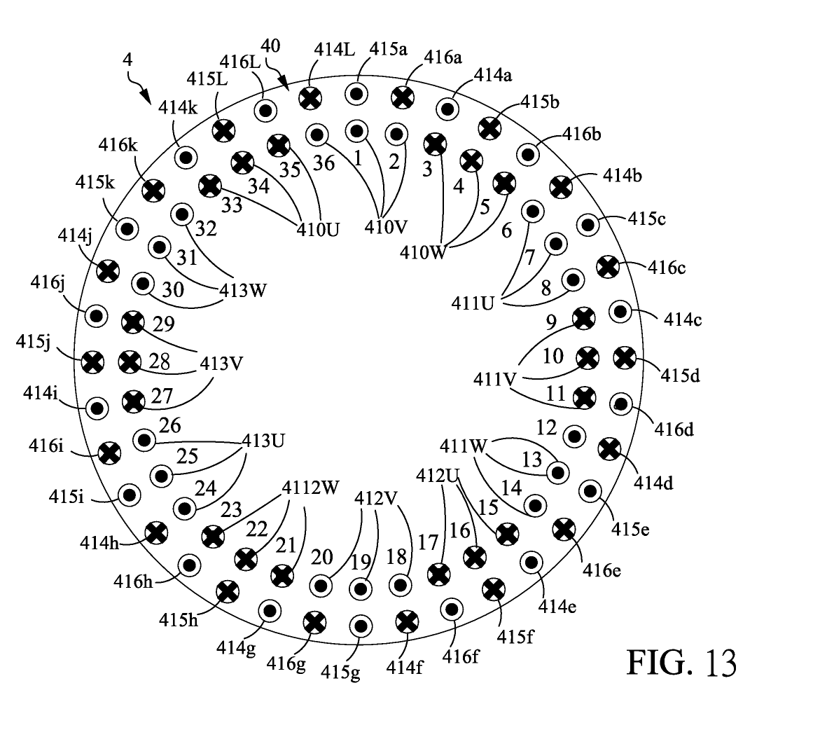

Please refer to FIG. 13, which is a schematic diagram showing the switching between 4-pole operation and 12-pole operation in the stator winding of FIG. 9. In the 4-pole changeable pole stator of FIG. 9, there is only one winding group being excited for each pole and each phase. However, in the embodiment shown in FIG. 13, the amount of winding group being excited corresponding to each phase and each pole is increased to be three, so as to minimizing the adverse effect of harmonics and also increase the efficiency of the induction motor. As shown in FIG. 13, the single-layer winding 40 has two rings of windings, i.e. an inner ring for 4-pole operation and an outer ring for 12-pole operation. In this embodiment, the slots of 4-pole U-phase in the inner ring are numbered by 410U˜413U, the slots of 4-pole V-phase in the inner ring are numbered by 410V˜413V, the slots of 4-pole W-phase in the inner ring are numbered by 410W˜413W, the slots of 12-pole U-phase in the outer ring are numbered by 414a˜413L, the slots of 12-pole V-phase in the outer ring are numbered by 415a˜415L, and the slots of 12-pole W-phase in the outer ring are numbered by 416a˜416L. Moreover, in FIG. 13, the solid dots represent current inflow and the symbol “X” represent current outflow. Accordingly, there are nine groups being classified as listed in Table 4, as following:

TABLE 4

| | | | | Coils in slots that | |
|---|---|---|---|---|---|
| | | | Current | are connected | Representing |
| group | 4-pole | 12-pole | direction | in series | symbol |
| 1 | V-phase | V-phase | same | 1-10-19-28 | 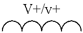 |
| 2 | W- phase | V-phase | same | 4-13-22-31 | 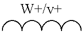 |
| 3 | U-phase | V-phase | same | 7-16-25-34 | 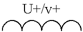 |
| 4 | V-phase | W- phase | opposite | 2-11-20-29 | 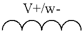 |
| 5 | W- phase | W- phase | opposite | 5-14-23-32 | 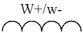 |
| 6 | U-phase | W- phase | opposite | 8-17-26-35 | 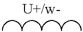 |
| 7 | V-phase | U-phase | opposite | 9-18-27-34 | 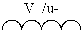 |
| 8 | W- phase | U-phase | opposite | 3-12-21-30 | 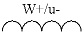 |
| 9 | U-phase | U-phase | opposite | 6-15-24-33 | 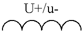 |

In Table 4, the current directions remain unchanged before and after a 4-pole V-phase/12-pole V-phase change operation, a 4-pole W-phase/12-pole V-phase change operation, and a 4-pole U-phase/12-pole V-phase change operation, while the current directions are reversed before and after a 4-pole V-phase/12-pole U-phase change operation, a 4-pole W-phase/12-pole U-phase change operation, a 4-pole U-phase/12-pole U-phase change operation, a 4-pole V-phase/12-pole W-phase change operation, a 4-pole W-phase/12-pole W-phase change operation, and a 4-pole U-phase/12-pole W-phase change operation.

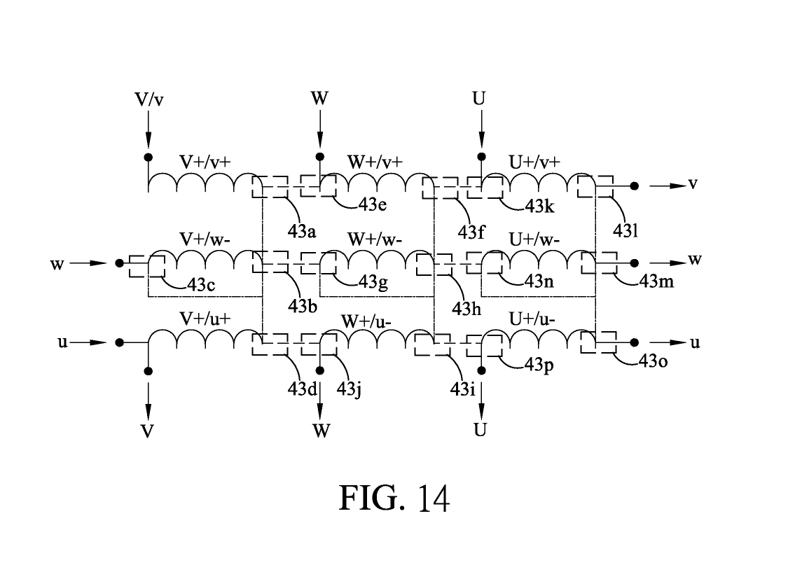

The plural winding groups are serially connected to one another via a plurality of switching elements 43a˜43p, as shown in FIG. 14. Thereby, by the switching of the switching elements 43a˜43d, the three set of winding groups, i.e. the V+/v+ winding group, the V+/w− winding group and the V+/a+ winding group, are connected for achieving a 4-pole V-phase winding; by the switching of the switching elements 43e˜43j, another three set of winding groups, i.e. the W+/v+ winding group, the W+/w− winding group and the W+/a+ winding group, are connected for achieving a 4-pole W-phase winding; and by the switching of the switching elements 43k˜43p, the three set of winding groups, i.e. the U+/v+ winding group, the U+/w− winding group and the U+/u− winding group, are connected for achieving a 4-pole U-phase winding. In addition, the set of the V+/v+ winding group, the W+/v+ winding group and the U+/v+ winding group can be converted to achieved a 12-pole V-phase winding by the switching of the switching elements 43a, 43e, 43f, 43k and 43l; and the set of the V+/w− winding group, the W+/w− winding group and the U+/w− winding group can be converted to achieved a 12-pole W-phase winding by the switching of the switching elements 43c, 43b, 43g, 43h and 43m; and the set of the V+/u+ winding group, the W+/u− winding group and the U+/u− winding group can be converted to achieved a 12-pole U-phase winding by the switching of the switching elements 43d, 43j, 43i, 43p and 43o. It is noted that the winding groups in this embodiment can be connected by a Y connection, a delta connection or a phase independent connection so as to achieve a circuit of FIG. 14, that is a circuit of a 4-pole/12-pole induction motor having three winding groups being excited in each phase and each pole in 4-pole operation. Since the Y connection, delta connection and phase independent connection are known to those skilled in the art and thus will not be described further herein.

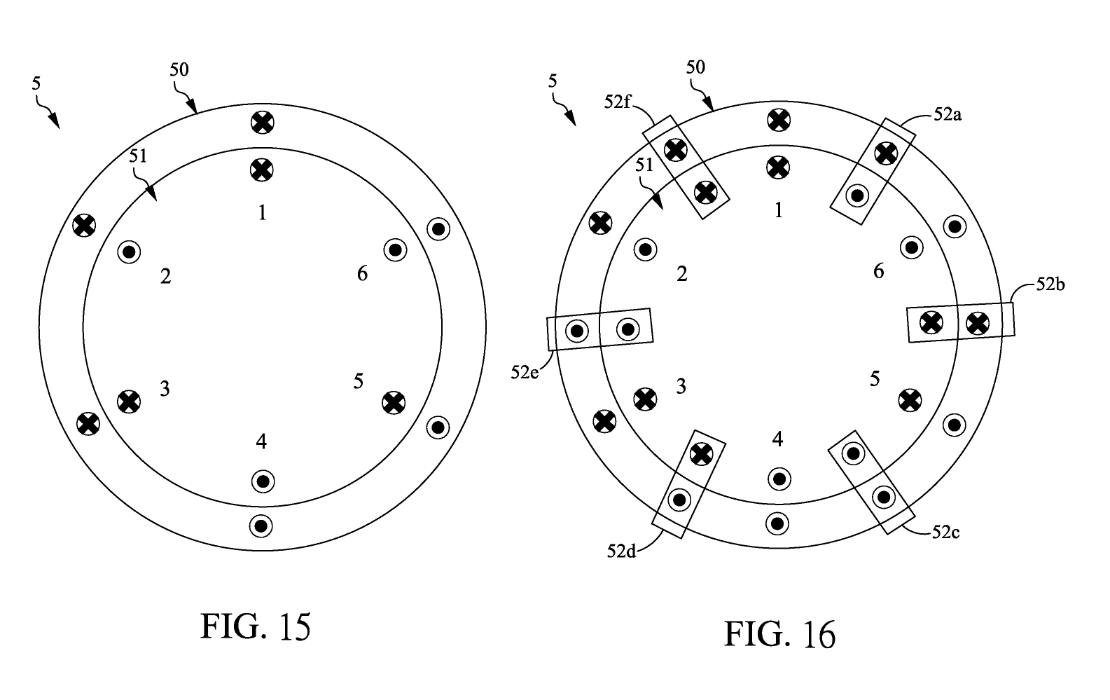

The previous embodiments described in the present disclosure are winding methods for a double-layer three-phase pole changeable stator and a single-layer three-phase pole changeable stator. However, the winding method disclosed in FIG. 1 or FIG. 6 can also be used for achieving a single-phase pole changeable stator. Please refer to FIG. 15, which is a schematic diagram showing a signal-phase 2-pole/6-pole changeable double-layer stator. In FIG. 15, a stator winding 5 is determined according to the step 20 of FIG. 1, which includes an outer layer winding 50 and an inner layer winding 51. After the completing of step 20, the step 21 is performed for electrically coupling the coils in slots conforming to the same classification conditions for thereby obtaining a plurality of winding groups. Thereafter, the step 22 is performed for enabling the plural winding groups to be electrically coupled to one another using a plurality of switching elements so as to form a pole-changing stator winding. In this embodiment, a pole changing from 2 pole to 6 pole, the currents flowing in the coils of slot 2 and 5 are changed while the currents of other slots remain unchanged. Accordingly, there can be two winding groups, as listed in the following Table 5.

TABLE 5

| | Current | Coils in slots that are | |
|---|---|---|---|
| Group | direction | connected in series | Coil symbol |
| 1 | same | 1-3-4-6 | 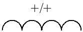 |
| 2 | opposite | 2-5 | 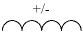 |

In addition, there can be a set of auxiliary windings 52a˜52f for assisting the primary stator winding of a single phase induction motor, which is disposed in about 90-degree phase difference from the primary winding, as shown in FIG. 16. Please refer to FIG. 17, which is a circuit diagram of a signal-phase 2-pole/6-pole changeable double-layer stator. The circuit of FIG. 17 is formed according to the step 23 of FIG. 1, which include a left-half circuit 54 and a right-half circuit 55. The left-half circuit 54 represents a primary winding shown in FIG. 15, while the right-half circuit represents the set of auxiliary windings 52a˜52f. Since the phase difference between the auxiliary windings and the primary winding is about 90 degrees, a capacitance 53 is required in the circuit of FIG. 17 that is serially connected to the left-half and the right-half circuits 54, 55. In the circuit shown in FIG. 17, a switching element 56 is used for enabling the current in the first winding group (+/+) to flow in the same direction as that of the second winding group (+/−), or opposite to that of the second winding group (+/−) so as to enable a pole change. Moreover, since the equivalent impedances of the first group (+1+) is not equal to the equivalent impedance of the second winding group (+/−), a compensation winding 57 is required that is serial connected to the second winding group (+/−) for balancing the impedance difference between the two winding groups.

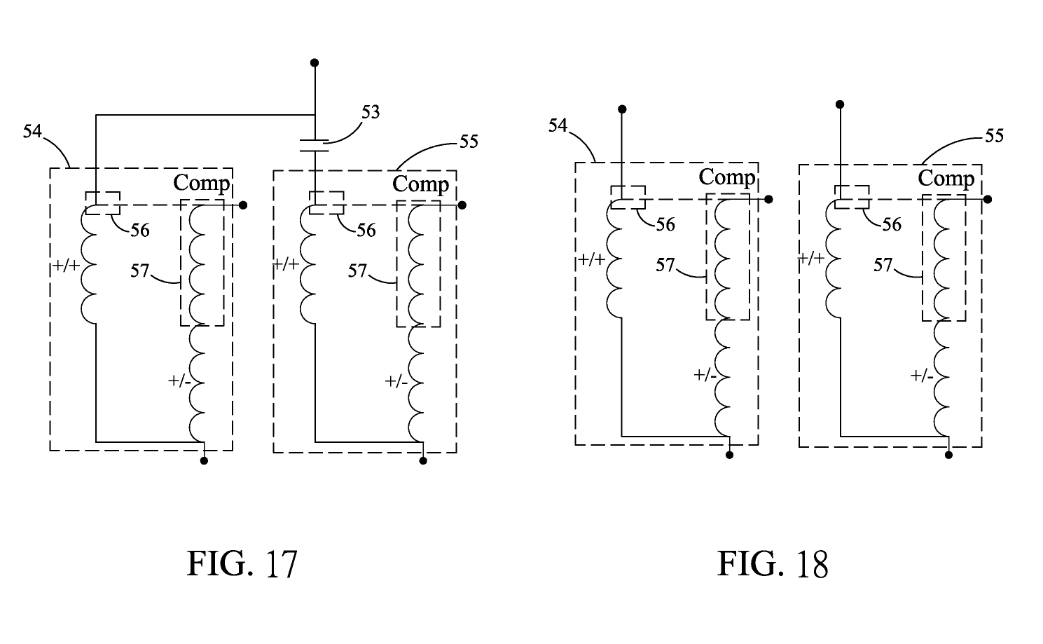

As shown in FIG. 16, a two-phase pole changing can also be achieved. It is noted that the stator winding for two-phase pole changeable motor is basically the same as that of the single-phase pole changeable motor, but is different in that: in a single-phase motor, the required 90-degree phase difference is established by the addition of a capacitance on the auxiliary winding; but for a two-phase motor, an additional power of 90-degree phase difference is used for powering the auxiliary winding 52a˜52f. That is, the auxiliary winding 52a˜52f of FIG. 16 is powered by a second-phase power source and the second-phase power source is designed to have a 90-degree phase difference from the first phase power source. As shown in FIG. 18, the left-half circuit that is a primary winding 54 is powered by a first phase power source, while the right-half circuit that is a set of auxiliary windings 55 is powered by a second phase power source, and the phase difference between the first phase power source and the second phase power source is about 901 degrees. Similarly, a switching element 56 is used for enabling the current in the first winding group (+/+) to flow in the same direction as that of the second winding group (+/−), or opposite to that of the second winding group (+/−) so as to enable a pole change.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A winding method for pole changeable stator, comprising the steps of:
establishing a stator winding according to the amount of slots in a stator as well as a phase selected from a plurality of phases and a plural types of pole that are intended to be switchably and selectively enabled in the stator while allowing each slot to house a coil;
determining a plurality of classification conditions according to the type of pole of the stator, the plural phases, and current characteristic of the coil of each slot in the stator before and after a pole change operation;
electrically coupling the coils in slots conforming to the same classification condition for thereby obtaining a plurality of winding groups respectively corresponding to the plural classification conditions while allowing each winding group to act corresponding to at least one of the plural types of pole, at least one phase of the plural phases, and the current characteristic of the at least one type of pole; and
enabling the plural winding groups to be electrically coupled to one another using a plurality of switching elements so as to form a pole-changing stator winding.

2. The winding method for pole changeable stator of claim 1, further comprising the steps of:
inspecting the winding groups of various phases that are corresponding respectively to different types of pole and are electrically connected to each other to determine whether the equivalent impedances of the winding groups in a winding set corresponding to one same phase at the same pole for each of the various phases are matched to one another or not; and
while there is one winding group in its winding set whose equivalent impedance is not match to the other winding groups, and then providing a compensation winding to be coupled to the end of the winding set with the unmatched winding group.

3. The winding method for pole changeable stator of claim 1, wherein the plural types of pole includes: M pole and N pole, the plural phases includes: U-phase, V-phase and W-phase; and each of the plural classification conditions is a combination of at least two terms selected from the groups consisting of the following term a to term x, which are:
a. U-phase is excited at N pole and U-phase is excited at M pole, and current direction remains unchanged before and after the pole change operation;
b. U-phase is excited at N pole and U-phase is excited at M pole, and current direction is revered before and after the pole change operation;
c. U-phase is excited at N pole and V-phase is excited at M pole, and current direction remains unchanged before and after the pole change operation;
d. U-phase is excited at N pole and V-phase is excited at M pole, and current direction is reversed before and after the pole change operation;
e. U-phase is excited at N pole and W-phase is excited at M pole, and current direction remains unchanged before and after the pole change operation;
f. U-phase is excited at N pole and W-phase is excited at M pole, and current direction is reversed before and after the pole change operation;
g. V-phase is excited at N pole and U-phase is excited at M pole, and current direction remains unchanged before and after the pole change operation;
h. V-phase is excited at N pole and U-phase is excited at M pole, and current direction is reversed before and after the pole change operation;
i. V-phase is excited at N pole and V-phase is excited at M pole, and current direction remains unchanged before and after the pole change operation;
j. V-phase is excited at N pole and V-phase is excited at M pole, and current direction is reversed before and after the pole change operation;
k. V-phase is excited at N pole and W-phase is excited at M pole, and current direction remains unchanged before and after the pole change operation;
l. V-phase is excited at N pole and W-phase is excited at M pole, and current direction is reversed before and after the pole change operation;
m. W-phase is excited at N pole and U-phase is excited at M pole, and current direction remains unchanged before and after the pole change operation;
n. W-phase is excited at N pole and U-phase is excited at M pole, and current direction is reversed before and after the pole change operation;
o. W-phase is excited at N pole and V-phase is excited at M pole, and current direction remains unchanged before and after the pole change operation;
p. W-phase is excited at N pole and V-phase is excited at M pole, and current direction is reversed before and after the pole change operation;
q. W-phase is excited at N pole and W-phase is excited at M pole, and current direction remains unchanged before and after the pole change operation;
r. W-phase is excited at N pole and W-phase is excited at M pole, and current direction is reversed before and after the pole change operation;
s. no excitation at N pole and U-phase is excited at M pole;
t. no excitation at N pole and V-phase is excited at M pole;
u. no excitation at N pole and W-phase is excited at M pole;
v. U-phase is excited at N pole and no excitation at M pole;
w. V-phase is excited at N pole and no excitation at M pole; and
x. W-phase is excited at N pole and no excitation at M pole.

4. The winding method for pole changeable stator of claim 1, wherein the step of electrically coupling the coils in slots conforming to the same classification condition for thereby obtaining a plurality of winding groups further comprises the steps of:
enabling the coils in the slots of the same winding group to be connected in a manner that any two coils of opposite current directions in each winding group are paired and connected to each other until all the coils are paired so as to form a plurality of sub-winding group for each winding group; and
connecting the plural sub-winding group of the same winding group by a coupling manner so as to achieve the corresponding winding group.

5. The winding method for pole changeable stator of claim 4, wherein the coupling manner is a connection selected from the group consisting of: a serial connection and a parallel connection.

6. The winding method for pole changeable stator of claim 1, wherein the plural winding groups are connected using a plurality of switching elements in a manner selected from the group consisting of: a Y connection, a delta connection and a phase independent connection.

7. The winding method for pole changeable stator of claim 1, wherein each of the plural switching element is a device selected from the group consisting of: a mechanical switch, a relay, and a power electronic unit.

8. The winding method for pole changeable stator of claim 1, wherein the pole-changing stator winding is a device selected from the group consisting of: a stator winding of pole-changing induction motors, a stator winding of pole-changing magnetic reluctance motors; a stator winding of pole-changing permanent magnet motors, and a stator winding of generators.

9. The winding method for pole changeable stator of claim 1, wherein the stator winding is a winding selected from the group consisting of: a single-layer winding and a multi-layer winding.

10. The winding method for pole changeable stator of claim 9, wherein the stator winding is a single-layer winding, the amount of slots is 18N, and the poles of the stator are adapted for switching between 2N-pole operation and 6N-pole operation, whereas N is a natural number.

11. The winding method for pole changeable stator of claim 1, wherein the current characteristic is an attribute selected from the group consisting of: current direction, current magnitude and the combination thereof.

12. An electro-mechanical conversion apparatus, comprising:
a stator, having a plurality of slots and a plurality of winding groups configured thereat in a manner that each slot has a coil housed therein, and each of the winding group is formed by connecting the coils in the slots conforming to one same classification condition selected from a plurality of classification conditions while allowing each winding group to act corresponding to at least one of a plural types of pole, at least one phase of various phase phases, and current characteristic of the at least one type of pole;
a plurality of switching elements, electrically connecting to the plural winding groups;
a control unit, for controlling the plural switching elements to change the pole of the stator according to the type of pole that is intended for the stator; and
a rotor, disposed on the stator while allowing the rotor to rotate inside the stator.

13. The electro-mechanical conversion apparatus of claim 12, wherein by the control of the control unit, the plural switching elements are enabled to connect the winding groups of the various phases to one another in response to each of the plural types of pole so as to form a plurality of winding sets corresponding respectively to each of the various phases.

14. The electro-mechanical conversion apparatus of claim 13, further comprising:
a compensation winding, coupled to the end of any one of the winding sets having winding groups with the unmatched equivalent impedances.

15. The electro-mechanical conversion apparatus of claim 12, wherein each of the plural classification conditions is a combination of at least two terms selected from the groups consisting of the following term a to term x, which are:
a. U-phase is excited at N pole and U-phase is excited at M pole, and current direction remains unchanged before and after the pole change operation;
b. U-phase is excited at N pole and U-phase is excited at M pole, and current direction is revered before and after the pole change operation;
c. U-phase is excited at N pole and V-phase is excited at M pole, and current direction remains unchanged before and after the pole change operation;
d. U-phase is excited at N pole and V-phase is excited at M pole, and current direction is reversed before and after the pole change operation;
e. U-phase is excited at N pole and W-phase is excited at M pole, and current direction remains unchanged before and after the pole change operation;
f. U-phase is excited at N pole and W-phase is excited at M pole, and current direction is reversed before and after the pole change operation;
g. V-phase is excited at N pole and U-phase is excited at M pole, and current direction remains unchanged before and after the pole change operation;
h. V-phase is excited at N pole and U-phase is excited at M pole, and current direction is reversed before and after the pole change operation;
i. V-phase is excited at N pole and V-phase is excited at M pole, and current direction remains unchanged before and after the pole change operation;
j. V-phase is excited at N pole and V-phase is excited at M pole, and current direction is reversed before and after the pole change operation;
k. V-phase is excited at N pole and W-phase is excited at M pole, and current direction remains unchanged before and after the pole change operation;
l. V-phase is excited at N pole and W-phase is excited at M pole, and current direction is reversed before and after the pole change operation;
m. W-phase is excited at N pole and U-phase is excited at M pole, and current direction remains unchanged before and after the pole change operation;
n. W-phase is excited at N pole and U-phase is excited at M pole, and current direction is reversed before and after the pole change operation;
o. W-phase is excited at N pole and V-phase is excited at M pole, and current direction remains unchanged before and after the pole change operation;
p. W-phase is excited at N pole and V-phase is excited at M pole, and current direction is reversed before and after the pole change operation;
q. W-phase is excited at N pole and W-phase is excited at M pole, and current direction remains unchanged before and after the pole change operation;
r. W-phase is excited at N pole and W-phase is excited at M pole, and current direction is reversed before and after the pole change operation;
s. no excitation at N pole and U-phase is excited at M pole;
t. no excitation at N pole and V-phase is excited at M pole;
u. no excitation at N pole and W-phase is excited at M pole;
v. U-phase is excited at N pole and no excitation at M pole;
w. V-phase is excited at N pole and no excitation at M pole; and
x. W-phase is excited at N pole and no excitation at M pole.

16. The electro-mechanical conversion apparatus of claim 12, wherein each of the winding groups further comprises: a plurality of sub-winding groups, each formed by the step of: enabling the coils in the slots of the same winding group to be connected in a manner that any two coils of opposite current directions in each winding group are paired and connected to each other until all the coils are paired so as to form the plural sub-winding group for the corresponding winding group; and the sub-winding groups of the same winding group are connected to one another using a coupling manner so as to achieve the corresponding winding group.

17. The electro-mechanical conversion apparatus of claim 16, wherein the coupling manner is a connection selected from the group consisting of: a serial connection and a parallel connection.

18. The electro-mechanical conversion apparatus of claim 12, wherein the plural winding groups are connected using the plural switching elements in a manner selected from the group consisting of: a Y connection, a delta connection and a phase independent connection.

19. The electro-mechanical conversion apparatus of claim 12, wherein each of the plural switching element is a device selected from the group consisting of: a mechanical switch, a relay, and a power electronic unit.

20. The electro-mechanical conversion apparatus of claim 12, wherein the stator is a unit selected from the group consisting of: a stator of induction motors, a stator of magnetic reluctance motors, a stator of permanent magnet motors and a stator of generators.

21. The electro-mechanical conversion apparatus of claim 12, wherein the stator is formed with a winding selected from the group consisting of: a single-layer winding and a multi-layer winding.

22. The electro-mechanical conversion apparatus of claim 21, wherein the winding of the stator is a single-layer winding, the amount of slots is 18N, and the poles of the stator are adapted for switching between 2N-pole operation and 6N-pole operation, whereas N is a natural number.

23. The electro-mechanical conversion apparatus of claim 12, wherein the current characteristic is an attribute selected from the group consisting of: current direction, current magnitude and the combination thereof.

24. An electro-mechanical conversion apparatus, adapted for switching between 2N-pole operation and 6N-pole operation, and N is a natural number, the electro-mechanical conversion apparatus comprising:
a stator, formed with 18N slots while enabling each slot to house and couple to a coil; wherein, all the coils of U-phase in the slots of the stator corresponding 2N-pole operation are connected in series so as to form a first winding group; all the coils of V-phase in the slots of the stator corresponding 2N-pole operation are connected in series so as to form a second winding group; all the coils of W-phase in the slots of the stator corresponding 2N-pole operation are connected in series so as to form a third winding group; all the coils of U-phase in the slots of the stator corresponding 6N-pole operation are connected in series so as to form a fourth winding group; all the coils of W-phase in the slots of the stator corresponding 6N-pole operation are connected in series so as to form a fifth winding group; and thereby, during the 2N-pole operation, the first winding group, the second winding group and the third winding group are arranged coupling to one another in a first coupling manner; and during the 6N-pole operation, the first winding group, the second winding group and the third winding group are arranged coupling to one another into a 6N-pole V-phase circuit while allowing the fourth winding group and the fifth winding group to be arranged coupling to one another in a second coupling manner.

25. The electro-mechanical conversion apparatus of claim 24, wherein the first coupling manner is a connection selected from the group consisting of: a Y connection, and a delta connection.

26. The electro-mechanical conversion apparatus of claim 24, wherein the second coupling manner is a connection selected from the group consisting of: a Y connection, and a delta connection.

27. The electro-mechanical conversion apparatus of claim 24, wherein during the 6N-pole operation, the first winding group, the second winding group and the third winding group are arranged coupling to one another in series using a switching element so as to achieve the 6N-pole V-phase circuit.

28. The electro-mechanical conversion apparatus of claim 27, wherein the switching element is a device selected from the group consisting of: a mechanical switch, a relay, and a power electronic unit.

29. The electro-mechanical conversion apparatus of claim 24, wherein the stator is a unit selected from the group consisting of: a stator of induction motors, a stator of magnetic reluctance motors, a stator of permanent magnet motors and a stator of generators.

30. The electro-mechanical conversion apparatus of claim 24, wherein the stator is formed with a winding selected from the group consisting of: a single-layer winding and a multi-layer winding.
